(19) United States
(12) Patent Application Publication
(10) Pub. No.: US 2025/0240732 A1
(43) Pub. Date: Jul. 24, 2025

(54) EXTENDED DISCONTINUOUS RECEPTION TIMELINE SEARCHING

(71) Applicant: QUALCOMM Incorporated, San Diego, CA (US)

(72) Inventors: Deeptanshu SHUKLA, Bangalore (IN); Shat PRATEEK, Agra (IN)

(21) Appl. No.: 18/419,197

(22) Filed: Jan. 22, 2024

(51) Int. Cl. H04W 52/02; H04W 56/00; H04W 68/02; H04W 76/28

(52) U.S. Cl. CPC H04W 52/028; H04W 56/0015; H04W 68/02; H04W 76/28

(57) ABSTRACT

Apparatus and methods for eDRx timeline searching are described. An apparatus is configured to switch, at a start of a sample capture window that is prior to a target wakeup time, from an eDRx sleep mode of operation to an eDRx active mode of operation. The target wakeup time is associated with at least one of a synchronization signal or a PBCH of a network node. The apparatus is configured to operate in a low power mode, subsequent to the target wakeup time and prior to a PO, based on a detection of at least one of the synchronization signal or the PBCH.

### TECHNICAL FIELD

The present disclosure relates generally to communication systems, and more particularly, to wireless communications utilizing extended discontinuous reception (eDRx).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may comprise a user equipment (UE), and the method may be performed at/by a UE. The apparatus is configured to switch, at a wakeup time for a start of a sample capture window that is prior to a target signal, from an extended discontinuous reception (eDRx) sleep mode of operation to an eDRx active mode of operation, where the target signal is associated with at least one of a synchronization signal or a physical broadcast channel (PBCH) of a network node. The apparatus is also configured to operate, subsequent to the target signal and prior to a paging occasion (PO), in a low power mode based on a detection of at least one of the synchronization signal or the PBCH.

In the aspect, the method includes switching, at a wakeup time for a start of a sample capture window that is prior to a target signal, from an eDRx sleep mode of operation to an eDRx active mode of operation, where the target signal is associated with at least one of a synchronization signal or a PBCH of a network node. The method also includes operating, subsequent to the target signal and prior to a PO, in a low power mode based on a detection of at least one of the synchronization signal or the PBCH.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of an LTE eDRx search timeline.

FIG. 5 is a call flow diagram for wireless communications, in accordance with various aspects of the present disclosure.

FIG. 6 is a diagram illustrating an example of an LTE eDRx search timeline with a synchronization signal target, in accordance with various aspects of the present disclosure.

FIG. 7 is a diagram illustrating examples of LTE eDRx search timelines with a synchronization signal and PBCH target, in accordance with various aspects of the present disclosure.

FIG. 8 is a diagram illustrating an example of an LTE eDRx search timeline with early termination, in accordance with various aspects of the present disclosure.

FIG. 9 is a flowchart of a method of wireless communication, in accordance with various aspects of the present disclosure.

FIG. 10 is a flowchart of a method of wireless communication, in accordance with various aspects of the present disclosure.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

Wireless communication networks may be designed to support communications between network nodes (e.g., base stations, gNBs, etc.) and UEs. For instance, a network node and a UE in a wireless communication network may communicate in various configurations and using various communication schema to conserve power. One example communication scheme to conserve power is discontinuous reception (DRx). Another example communication scheme to conserve power is eDRx, which may be utilized for IoT devices, as well as in other device scenarios. In various implementations for IoT devices, eDRx power may be a key performance indicator (KPI) of these platforms. For instance, implementations with stringent power targets (e.g., ˜10 uA at the battery) under tight cost constraints and competitive pressure, may utilize eDRx to meet such targets.

However, an IoT architecture and/or a real-time operating system (RTOS) application that implements eDRx may incur other performance impacts to achieve power savings. As one example, a low-power sleep clock may be used to bring power down, but may come at the cost of high clock error/drift (e.g., 40-250 ppm). As an IoT device loses its time synchronization with the network during sleep due to clock drift, the device may perform a search in order to re-synchronize with the network upon waking up. In such cases, a larger clock drift that is realized during low power periods to conserve power may lead to longer and more power intensive searches for the re-synchronization with the network, which adversely impacts power savings.

Various aspects relate generally to eDRx. Some aspects more specifically relate to LTE eDRx search timeline optimizations. In some examples, a UE is configured to minimize eDRx search timelines and power consumption for power use to compensate for drift in low-power sleep clocks. For instance, a UE may be configured to wake up based on target signals prior to paging offsets (POs) or pages as the target. In one example, the UE may be configured to target a synchronization signal(s) and/or a physical broadcast channel (PBCH), rather than the PO associated with eDRx communications, and wake up at a time prior to the target signal.

Particular aspects of the subject matter described in this disclosure can be implemented to realize one or more of the following potential advantages. In some examples, by targeting a synchronization signal(s)/a PBCH for wakeup, rather than the PO associated with eDRx communications, the described techniques can be used to minimize eDRx search timelines and power consumption for power use to compensate for drift in low-power sleep clocks. In some examples, by implementing low power modes between synchronization signals and a PBCH in different subframes, the described techniques can be used to further reduce power consumption. In some examples, by performing early termination of searches for re-synchronization, the described techniques can be used to reduce power consumption further still.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

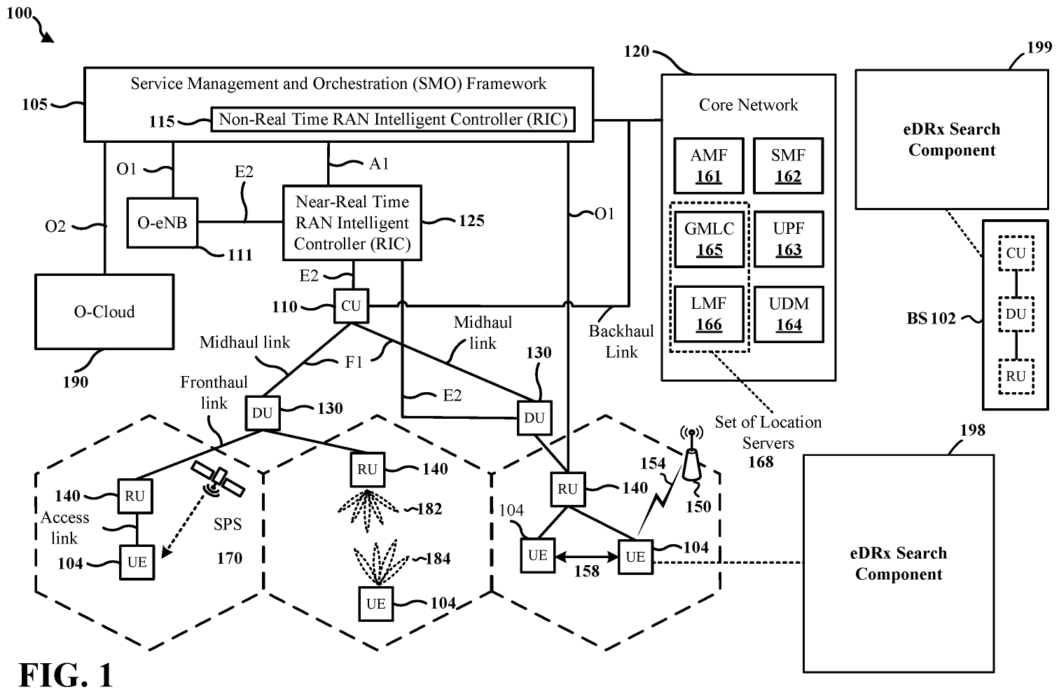

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an AI interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an eDRx search component 198 (“component 198”) that may be configured to switch, at a wakeup time for a start of a sample capture window that is prior to a target signal, from an eDRx sleep mode of operation to an eDRx active mode of operation, where the target signal is associated with at least one of a synchronization signal or a PBCH of a network node. The component 198 may also be configured to operate, subsequent to the target signal and prior to a PO, in a low power mode based on a detection of at least one of the synchronization signal or the PBCH. The component 198 may be configured to obtain the wakeup time for the start of the sample capture window that is prior to the target signal that is associated with at least one of the synchronization signal or the PBCH, where the synchronization signal is at least one of a primary synchronization signal (PSS) or a secondary synchronization signal (SSS). The component 198 may be configured to decode the synchronization signal prior to operation in the low power mode and an associated termination of the sample capture window. The component 198 may be configured to decode the synchronization signal and the PBCH prior to operation in the low power mode and an associated termination of the sample capture window. The component 198 may be configured to switch, prior to the switch from the eDRx sleep mode of operation to the eDRx active mode of operation, from the eDRx active mode of operation to the eDRx sleep mode of operation, where the switch from the eDRx sleep mode of operation to the eDRx active mode of operation is based on the switch from the eDRx active mode of operation to the eDRx sleep mode of operation. The component 198 may be configured to output an indication of the operation in the low power mode based on the detection of at least one of the synchronization signal or the PBCH. The component 198 may be configured to receive, from the network node via the transceiver, at least one transmission, where the at least one transmission includes at least one of the synchronization signal or the PBCH. In certain aspects, the base station 102 may have an eDRx search component 199 (“component 199”) that may be configured to provide, for a UE, a target signal that is associated with at least one of a synchronization signal or a PBCH, where the synchronization signal is at least one of a primary synchronization signal (PSS) or a secondary synchronization signal (SSS). The component 199 may be configured to transmit, for the UE, at least one of the synchronization signal or the PBCH. The component 199 may be configured to receive, from the UE, an indication of an operation in a low power mode at the UE based on a detection of at least one of the synchronization signal or the PBCH by the UE. Accordingly, aspects provide for minimizations of eDRx search timelines and power consumption for power use to compensate for drift in low-power sleep clocks by targeting wakeup times prior to POs or pages for synchronization signal(s) and/or a PBCH, rather than the PO associated with eDRx communications.

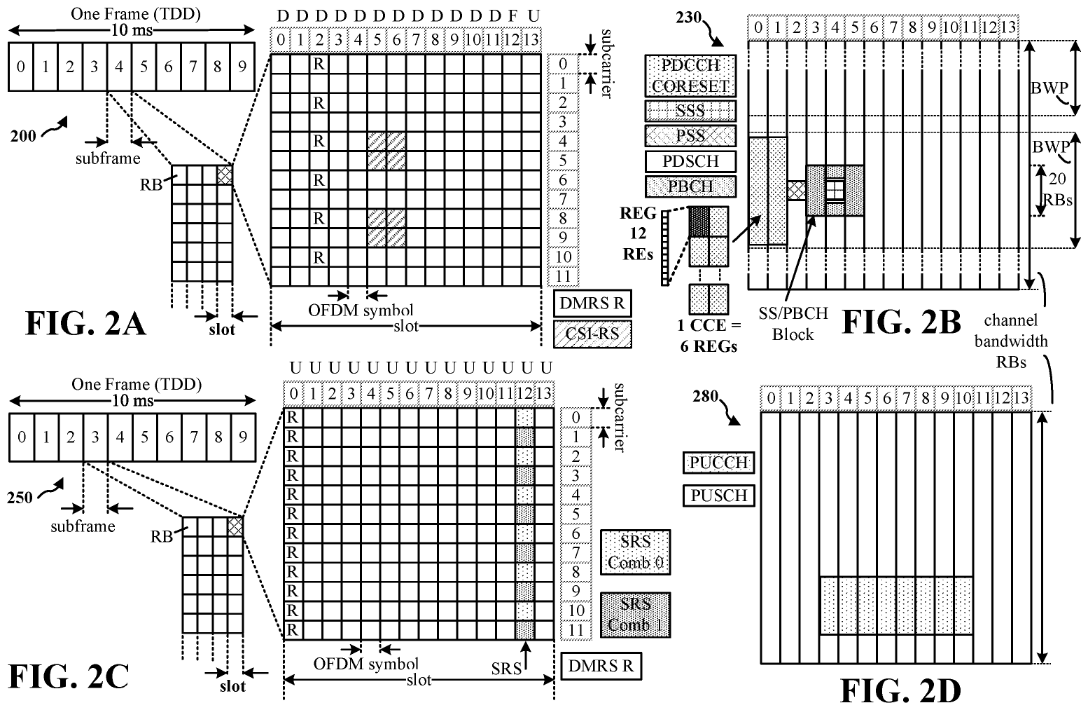

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

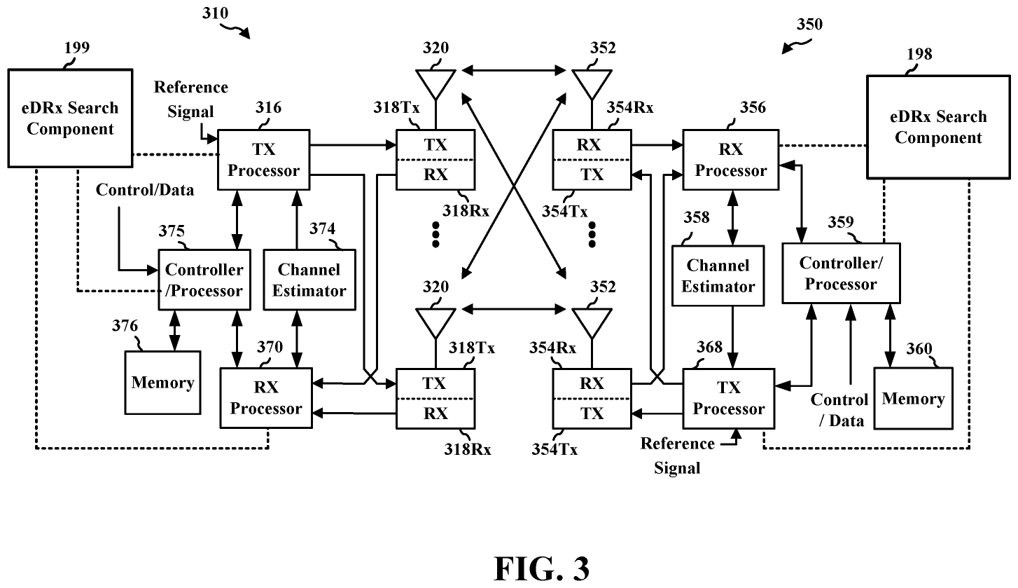

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1.

At least one of the TX processor 316, the RX processor 370, and the controller/processor 375 may be configured to perform aspects in connection with the component 199 of FIG. 1.

Network nodes and UEs may communicate in wireless communication networks with various configurations and using various communication schema to conserve power. In various implementations for IoT devices, eDRx power may be a KPI of these platforms. For instance, implementations with stringent power targets (e.g., ˜10 uA at the battery) under tight cost constraints and competitive pressure, may utilize eDRx to meet such targets.

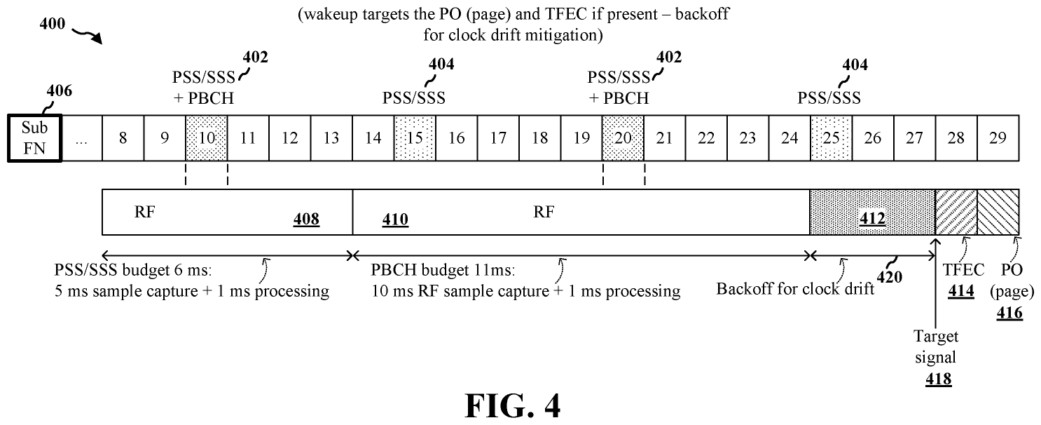

FIG. 4 is a diagram 400 illustrating an example of an LTE eDRx search timeline. The diagram 400 shows an eDRx configuration in which a UE is configured to wake up based on a target signal 418, e.g., a PO 416 (and/or for time and frequency error correction (TFEC) 414 immediately preceding the PO 416).

As illustrated in diagram 400, instances 402 of PSS/SSS with PBCH and instances 404 of PSS/SSS without PBCH, e.g., PSS/SSS in the same subframe without PBCH in that same subframe, may be provided to a UE from a network node (e.g., a base station, gNB, etc.) at configured subframe numbers 406. As one example, the instances 402 of PSS/SSS with PBCH, e.g., PSS/SSS and PBCH all in the same subframe, may be provided to the UE every 10 subframes at the subframe numbers 406 of 10 and 20 (e.g., modulo 10), and the instances 404 of PSS/SSS without PBCH may be provided to the UE every 10 subframes at the subframe numbers 406 of 5, 15, and 25 (e.g., modulo 5). Additionally, as shown, the synchronization signals PSS/SSS may thus be provided every 5 subframes of the subframe numbers 406.

In the example shown, an RF search period 408 may be utilized to search for PSS/SSS transmissions from a network node. In some configurations, the budget for the RF search period 408 for the PSS/SSS search may be 6 ms (e.g., 5 ms for sample capture and 1 ms for processing) or 6 subframes, and may be irrespective of actual PSS/SSS location(s). An RF search period 410 may also be utilized to search for PBCH transmissions from the network node. In some configurations, the budget for the RF search period 410 for the PBCH search may be 11 ms (e.g., 10 ms for sample capture and 1 ms for processing) or 11 subframes. That is, some configurations may allow for 17 ms of active RF searching and processing for the instances 404 of PSS/SSS without PBCH and the instances 402 of PSS/SSS with PBCH in order to provide for capture of PSS/SSS and PBCH to resynchronize the UE with the network node. After the RF search period 410, and prior to the target signal 418, the UE may enter a low power mode of operation 412 for power conservation. Additionally, a backoff time 420 to further account for clock drift at the UE may be configured. The backoff time 420 may be 3 ms or more (e.g., 3 subframes or more) prior to the target signal 418 that is targeted for the PO 416 (and/or for the TFEC 414).

As noted above, an IoT architecture and/or a RTOS application that implements eDRx may incur other performance impacts to achieve power savings, such as via a low-power sleep clock having a high clock error/drift (e.g., 40-250 ppm). As an IoT device loses its time synchronization with the network during sleep due to clock drift, the device may perform a search in order to re-synchronize with the network upon waking up. In such cases, a larger clock drift that is realized during low power periods to conserve power may lead to longer and more power intensive searches for the re-synchronization with the network, which adversely impacts power savings.

The aspects herein provide for timeline (e.g., microsleep or other types of low power modes of operation) and processing optimizations of PSS, SSS, and/or PBCH during eDRX page monitoring. As one example, the aspects herein for LTE eDRx search timeline optimizations enable a UE to minimize eDRx search timelines and power consumption for power use to compensate for drift in low-power sleep clocks. A UE may be configured to target signals (e.g., PSS, SSS, and/or PBCH) prior to paging offsets POs or pages, e.g., by targeting a synchronization signal(s) and/or a PBCH, rather than the PO associated with eDRx communications. Aspects herein enable minimization of eDRx search timelines and power consumption for power use to compensate for drift in low-power sleep clocks by targeting a synchronization signal(s)/a PBCH, rather than the PO associated with eDRx communications. Aspects also provide for further reductions in power consumption by implementing low power modes between synchronization signals and a PBCH in different subframes. Aspect also provide for still further reductions in power consumption by performing early termination of searches for re-synchronization.

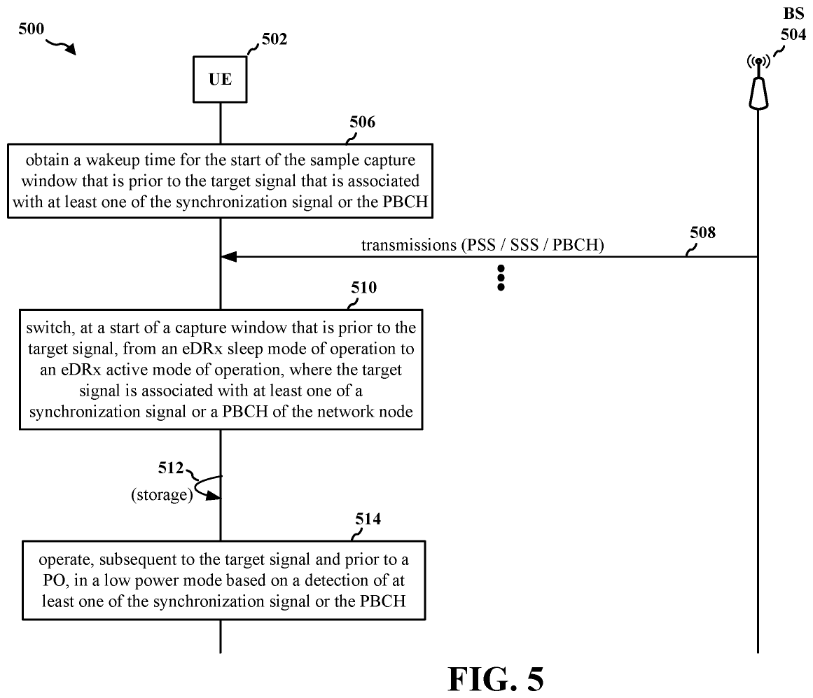

FIG. 5 is a call flow diagram 500 for wireless communications, in various aspects. Call flow diagram 500 illustrates LTE eDRx search timeline optimizations for a wireless device (a UE 502, by way of example) that communicates with the network node (a base station 504, such as a gNB or other type of base station, by way of example, as shown), in various aspects. Aspects described for the base station 504, and for network nodes herein, generally, may be performed by the base station in aggregated form and/or by one or more components of the base station in disaggregated form. Additionally, or alternatively, the aspects may be performed by the UE 502 autonomously, in addition to, and/or in lieu of, operations of the base station 504. In aspects, the UE may be an IoT device or a wireless device (e.g., a cellular phone, a smart phone, and/or the like).

In the illustrated aspect, the UE 502 may be configured to obtain (at 506) a wakeup time for the start of the sample capture window that is prior to the target signal that is associated with at least one of the synchronization signal or the PBCH. The UE 502 may be configured to calculate the wakeup time based on received parameters in signaling (e.g., RRC signaling, etc.) from the network node, in aspects, or may be configured with the wakeup time that may be stored in memory/in at least one memory of the UE 502 (e.g., by an OEM), from which the UE 502 may be configured to calculate/obtain (at 506) the wakeup time. The UE 502 may be configured with the wakeup time by a base station such as the base station 504 through calculated/obtained (at 506) signaling (e.g., via RRC signaling, via a medium access control (MAC) control element (MAC-CE), via DCI, etc.). In aspects, the UE 502 may maintain or track the obtained wakeup time, using a clock or a counter, based on a number of subframes, time, and/or the like.

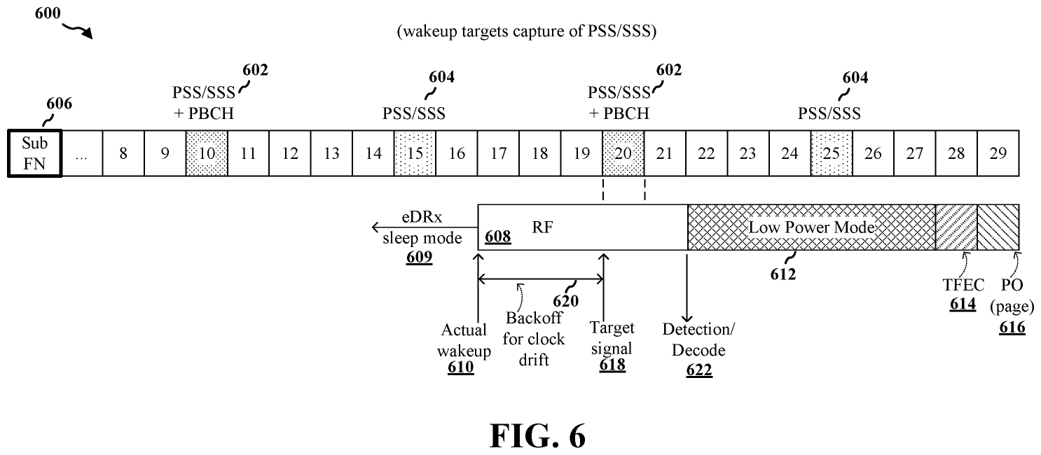

The UE 502 may be configured to receive, and the base station 504 may be configured to transmit/provide, transmissions 508. In aspects, UE 502 may be configured to receive, and the base station 504 may be configured to transmit/provide, the transmissions 508 as at least one of a synchronization signal or a PBCH of a network node (e.g., the base station 504). The synchronization signal may be at least one of a PSS or a SSS, in various aspects. It should be noted that the transmissions 508 may be received by the UE 502, and transmitted/provided by the base station 504, one or more times in various aspects of the call flow diagram 500 (e.g., as shown in FIGS. 6, 7, 9 and described below). In aspects, at least one of the synchronization signal or the PBCH of the transmission 508 may include a subframe number and/or a cell identifier for a cell which was obtained and known/stored by the UE 502 prior to the eDRx sleep mode of operation.

The UE 502 may be configured to switch (at 510), at a wakeup time for a start of a sample capture window that is prior to the target signal, from an eDRx sleep mode of operation to an eDRx active mode of operation. The target signal may be associated with at least one of a synchronization signal or a PBCH of the network node (e.g., the base station 504). In aspects, the eDRx active mode of operation may include communications with the network node (e.g., the base station 504), such as transmissions 508. In such aspects, the switch (at 510) from the eDRx sleep mode of operation to the eDRx active mode of operation may include the switch (at 510) being based on a backoff time associated with the start of the sample capture window. The backoff time may be prior to the target signal, in aspects.

The UE 502, when the target signal is associated with the synchronization signal (e.g., and not with the PBCH), may be configured to decode the synchronization signal prior to operating in the low power mode. In such aspects, the UE 502 may be configured to decode the synchronization signal and to decode the PBCH based on a PBCH detection indicative of a presence of the PBCH with the synchronization signal (e.g., in a same/single subframe as the synchronization signal). The UE 502, when the target signal is associated with the synchronization signal and with the PBCH, may be configured to decode the synchronization signal and the PBCH prior to operating in the low power mode. In some such aspects, when the synchronization signal and the PBCH are present in a single subframe, at least one of the synchronization signal or the PBCH may include a subframe number and/or a cell identifier for a cell (e.g., associated with the base station 504) which was obtained by the UE 502 prior to the eDRx sleep mode of operation, and the low power mode of operation may be a microsleep mode of operation, etc., based on the cell identifier having been obtained.

In others of such aspects, when the synchronization signal and the PBCH are present in different subframes, to decode the synchronization signal and the PBCH prior to operating in the low power mode, the UE 502 may be configured to decode the synchronization signal from a first subframe, to operate in the low power mode subsequent to the first subframe and prior to a second subframe that includes the PBCH, and to decode the PBCH from the second subframe, for which the UE 502 may be configured to operate in the eDRx active mode of operation from a start of the second subframe to after the second subframe and prior to operating in the low power mode subsequent to the target signal and prior to the PO. In some such aspects, when the synchronization signal and the PBCH are present in different subframes, at least one of the synchronization signal or the PBCH may include a subframe number and/or a cell identifier for a cell (e.g., associated with the base station 504) which was obtained by the UE 502 prior to the eDRx sleep mode of operation, and the low power mode of operation may be a microsleep mode of operation, etc., based on the cell identifier having been obtained.

The UE 502 may be configured to output an indication 512. The indication 512 may be an indication of the operation in the low power mode based on the detection of at least one of the synchronization signal or the PBCH. To output the indication 512, the UE 502 may be configured to store, in memory/a memory or a cache at the UE 502, the indication 512. In some aspects, to output the indication 512, the UE 502 may be configured to transmit/provide, and the base station 504 may be configured to receive, the indication 512 via wireless transmission.

The UE 502 may be configured to operate (at 514), subsequent to the target signal and prior to a PO (such as a next PO after the wakeup time and target signal), in a low power mode based on a detection of at least one of the synchronization signal or the PBCH. In aspects, operation in the low power mode may be associated with a termination of the sample capture window (e.g., and may correspondingly not sample/detect synchronization signals/PBCH), which may increase energy savings for the UE 502. In aspects, the low power mode of operation in which the UE 502 may be configured to operate (at 514) may be at least one of the eDRx sleep mode of operation, an extended low power mode of operation, or a microsleep mode of operation.

FIG. 6 is a diagram 600 illustrating an example of an LTE eDRx search timeline with a synchronization signal target, in various aspects. The diagram 600 shows an eDRx configuration in which a UE (e.g., the UE 502 in FIG. 5) may be configured to target a target signal 618 for a synchronization signal (e.g., PSS and/or SSS).

As illustrated in diagram 600, instances 602 of PSS/SSS with PBCH and instances 604 of PSS/SSS without PBCH may be provided to a UE from a network node (e.g., a base station, gNB, etc.) at configured subframe numbers 606. As one example, the instances 602 of PSS/SSS with PBCH may be provided to the UE every 10 subframes at the subframe numbers 606 of 10 and 20 (e.g., modulo 10), and the instances 604 of PSS/SSS without PBCH may be provided to the UE every 10 subframes at the subframe numbers 606 of 5, 15, and 25 (e.g., modulo 5). Additionally, as shown, the synchronization signals PSS/SSS, which may be the targets of the target signal 618, may thus be provided every 5 subframes of the subframe numbers 606.

In the illustrated aspect, an RF search period shown as a sample capture window 608, over which samples of synchronization signals/PBCH may be captured by the UE in an eDRx active mode of operation, may be utilized to search for PSS/SSS transmissions from a network node. The sample capture window 608 may be associated with the target signal 618 and may start prior to the target signal 618 based on a backoff 620. That is, based on the target signal 618 targeted by the UE and the backoff 620, the UE may actually wake up at an actual wakeup time 610 in order to sample synchronization signals/PBCH for resynchronization. Prior to the actual wakeup time 610, the UE may be in an eDRx sleep mode of operation 609.

In the diagram 600, the UE may be configured to ascertain a detection 622 of the synchronization signal(s) (e.g., PSS/SSS) in the one of instances 602 of PSS/SSS with PBCH corresponding to the subframe number 20 and perform decoding/processing thereof. The UE may be configured to decode the synchronization signal(s) as part of the detection 622, in aspects, during which a subframe number and/or cell identifier may be determined, e.g., from the PBCH. After the sample capture window 608 and prior to the PO 616 (and/or the TFEC 614), the UE may be configured to operate in a low power mode of operation 612. For example, with the detection 622 of the synchronization signal(s) (e.g., PSS/SSS) in the one of instances 602 of PSS/SSS with PBCH corresponding to the subframe number 20, the UE may be configured to determine its resynchronization with the network node and determine when the PO 616 (and/or the TFEC 614) will be transmitted, at which time the UE may enter an eDRx active mode of operation.

It should be noted that the synchronization signal(s) (e.g., PSS/SSS) in other ones of instances 602 of PSS/SSS with PBCH, as well as instances 604 of PSS/SSS without PBCH, may be utilized for the detection 622, in various configurations/aspects. Additionally, the UE may be configured to decode the synchronization signal(s) and to decode the PBCH based on a PBCH detection indicative of a presence of the PBCH with the synchronization signal (e.g., in a same/single subframe as the synchronization signal), during which a subframe number and/or cell identifier may be determined.

Thus, the duration of the sample capture window 608 may be decreased for the search for samples of synchronization signals/PBCH, while operation time in the low power mode, without additional samples based on the associated termination of the sample capture window, may be increased, and power savings may be achieved.

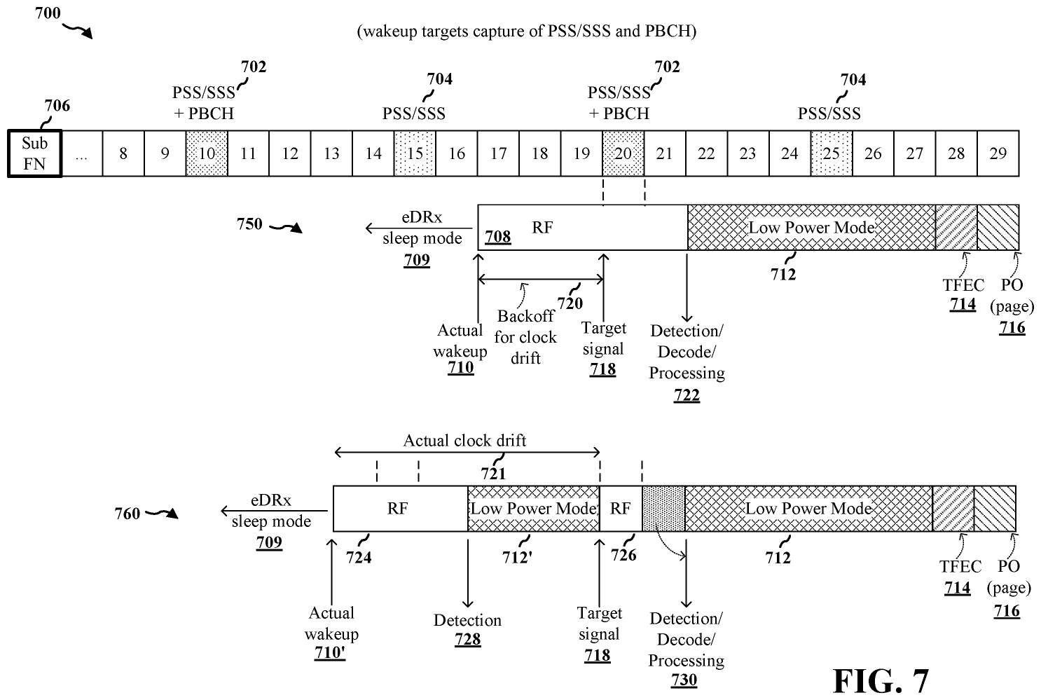

FIG. 7 is a diagram 700 illustrating examples of LTE eDRx search timelines with a synchronization signal and PBCH target, in various aspects. The diagram 700 shows an eDRx configuration 750 and an eDRx configuration 760 in which a UE (e.g., the UE 502 in FIG. 5) may be configured to target a target signal 718 for a synchronization signal (e.g., PSS and/or SSS) and a PBCH.

As illustrated in diagram 700, instances 702 of PSS/SSS with PBCH and instances 704 of PSS/SSS without PBCH may be provided to a UE from a network node (e.g., a base station, gNB, etc.) at configured subframe numbers 706. As one example, the instances 702 of PSS/SSS with PBCH may be provided to the UE every 10 subframes at the subframe numbers 706 of 10 and 20 (e.g., modulo 10), and the instances 704 of PSS/SSS without PBCH may be provided to the UE every 10 subframes at the subframe numbers 706 of 5, 15, and 25 (e.g., modulo 5). Additionally, as shown, the synchronization signals PSS/SSS, which may be the targets of the target signal 718, may thus be provided every 5 subframes of the subframe numbers 706.

In the illustrated aspect for the configuration 750, the synchronization signal(s) (e.g., PSS/SSS) and the PBCH are in a same/single subframe. An RF search period shown as a sample capture window 708, over which samples of synchronization signals/PBCH may be captured by the UE in an eDRx active mode of operation, may be utilized to search for PSS/SSS transmissions and PBCH from a network node. The sample capture window 708 may be associated with the target signal 718 and may start prior to the target signal 718 based on a backoff 720. That is, based on the target signal 718 targeted by the UE and the backoff 720, the UE may actually wake up at an actual wakeup time 710 in order to sample synchronization signals/PBCH for resynchronization. Prior to the actual wakeup time 710, the UE may be in an eDRx sleep mode of operation 709. In aspects herein, there may be a Sleep-to-Wakeup portion for the eDRx sleep mode of operation 709 where the UE/modem may come out of eDRx sleep and initialize its different components.

In the configuration 750, the UE may be configured to ascertain a detection 722 of the synchronization signal(s) (e.g., PSS/SSS) and the PBCH for processing from the one of the instances 702 of PSS/SSS with PBCH corresponding to the subframe number 20 (although other ones of the instances 702 of PSS/SSS with PBCH may be utilized in various configurations/aspects (e.g., one corresponding to the subframe number 10)). In aspects, the UE may be configured to decode the synchronization signal(s) (e.g., PSS/SSS) and to decode the PBCH based on a PBCH detection indicative of a presence of the PBCH with the synchronization signal (e.g., in a same/single subframe as the synchronization signal), during which a subframe number and/or cell identifier may be determined. After the sample capture window 708 and prior to the PO 716 (and/or the TFEC 714), the UE may be configured to operate in a low power mode of operation 712. For example, with the detection 722 of the synchronization signal(s) (e.g., PSS/SSS) and the PBCH in the one of instances 702 of PSS/SSS with PBCH corresponding to the subframe number 20, and associated PBCH processing, the UE may be configured to determine its resynchronization with the network node and determine when the PO 716 (and/or the TFEC 714) will be transmitted, at which time the UE may enter an eDRx active mode of operation.

Thus, the duration of the sample capture window 708 may be decreased for the search for samples of synchronization signals/PBCH, while operation time in the low power mode, without additional samples based on the associated termination of the sample capture window, may be increased, and power savings may be achieved.

In the illustrated aspect for the configuration 760, the synchronization signal(s) (e.g., PSS/SSS) and the PBCH are in different subframes. An RF search period shown as a sample capture window 724, over which samples of synchronization signals/PBCH may be captured by the UE in an eDRx active mode of operation, may be utilized to search for PSS/SSS transmissions and PBCH from a network node. The sample capture window 724 may be associated with the target signal 718 and may start prior to the target signal 718 based on an actual clock drift 721. That is, based on the target signal 718 targeted by the UE and the actual clock drift 721, the UE may actually wake up at an actual wakeup time 710′ in order to sample synchronization signals/PBCH for resynchronization. Prior to the actual wakeup time 710′, the UE may be in the eDRx sleep mode of operation 709.

In the configuration 760, the UE may be configured to ascertain detection of the synchronization signal(s) (e.g., PSS/SSS) and the PBCH for processing from the different subframes (e.g., one of the instances 702 of PSS/SSS with PBCH and one of the instances 704 of PSS/SSS without PBCH) due to clock drift. As shown, consecutive ones of the instances 702 of PSS/SSS with PBCH and the instances 704 of PSS/SSS without PBCH correspond to the subframe numbers 15 and 20 (although other ones of the instances 702 of PSS/SSS with PBCH and the instances 704 of PSS/SSS without PBCH may be utilized in various configurations/aspects).

The UE may be configured to ascertain a detection 728 of the synchronization signal(s) (e.g., PSS/SSS) from the one of the instances 704 of PSS/SSS without PBCH, which corresponds to the subframe number 15, as this may be the first one of the instances 704 of PSS/SSS without PBCH or the instances 702 of PSS/SSS with PBCH received after the actual wakeup time 710′. In aspects, the UE may be configured to decode the synchronization signal(s) (e.g., PSS/SSS) associated with the detection 728 thereof, during which a subframe number and/or cell identifier may be determined. After the sample capture window 724, which may end based on the detection 728, and prior to the target signal 718, the UE may be configured to operate in a low power mode of operation 712′. For example, with the detection 728 of the synchronization signal(s) (e.g., PSS/SSS) in the one of instances 704 of PSS/SSS without PBCH corresponding to the subframe number 15, and associated processing, the UE may be configured to determine at least a portion of its resynchronization with the network node and determine when the target signal 718 will be present, e.g., based on the synchronization signal(s) (e.g., PSS/SSS), at which time the UE may enter the low power mode of operation 712′ (e.g., an eDRx sleep mode of operation, an extended low power mode of operation, a microsleep mode of operation, etc.).

During a second sample capture window 726, in which the UE may be in an eDRx active mode of operation, the UE may be configured to ascertain a detection 730 of the PBCH from the one of the instances 702 of PSS/SSS with PBCH, which corresponds to the subframe number 20, as this may be the first/next one of the instances 704 of PSS/SSS without PBCH or the instances 702 of PSS/SSS with PBCH received after the detection 728 and initialization of the low power mode of operation 712′. The second sample capture window 726 may be shortened (e.g., 1 or 2 subframes in length, in aspects) based on the detection 728, which may enable the UE to obtain/determine the actual wakeup time 710′ for the target signal 718 for the subframe corresponding to the subframe number 20. In aspects, the UE may be configured to process/decode the PBCH based on a PBCH detection indicative of a presence of the PBCH with the synchronization signal (e.g., in a same/single, next subframe as the synchronization signal), during which a subframe number and/or cell identifier may be determined. After the second sample capture window 726/the detection 730 (e.g., which may include the PBCH processing/decoding) and prior to the PO 716 (and/or the TFEC 714), the UE may be configured to operate in a low power mode of operation 712 (e.g., an eDRx active mode of operation, microsleep, etc.). For example, with the detection 728 of the synchronization signal(s) (e.g., PSS/SSS) and the detection 730 of the PBCH in different ones of the instances 702 of PSS/SSS with PBCH and of the instances 704 of PSS/SSS without PBCH corresponding to the subframe numbers 15 and 20, and associated PBCH processing, the UE may be configured to determine its resynchronization with the network node and determine when the PO 716 (and/or the TFEC 714) will be transmitted, at which time the UE may enter an eDRx active mode of operation.

Thus, the duration of the sample capture windows (the sample capture window 724, the second sample capture window 726) may be decreased for the search for samples of synchronization signals/PBCH, while operation time in the low power mode, without additional samples based on the associated termination of the sample capture window, may be increased, and power savings may be achieved.

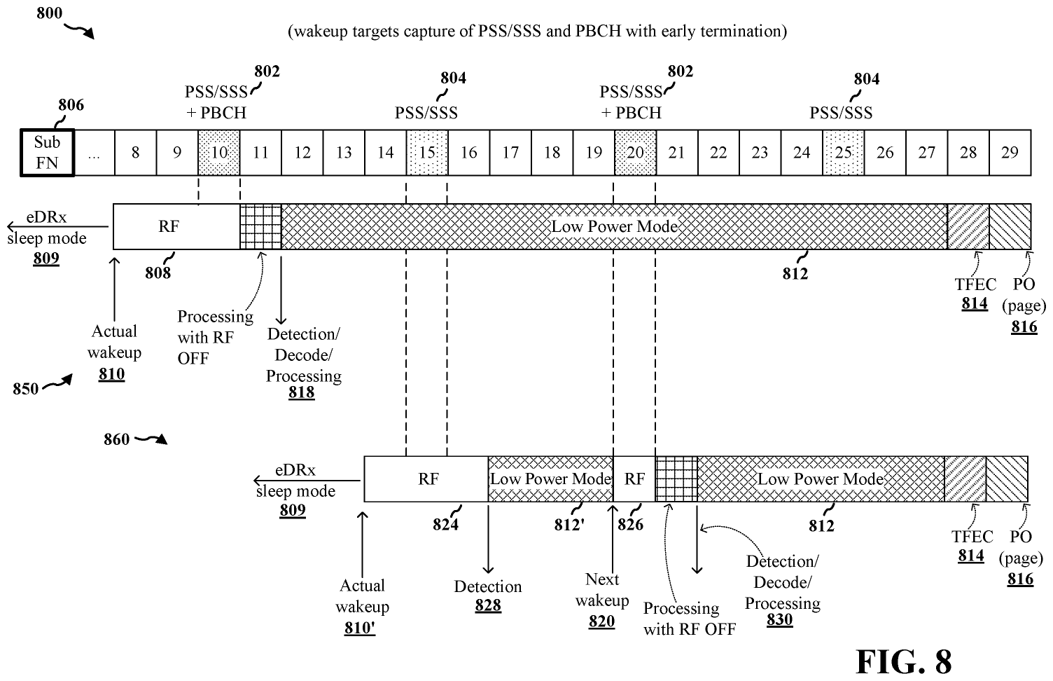

FIG. 8 is a diagram 800 illustrating an example of an LTE eDRx search timeline with early termination, in various aspects. The diagram 800 shows an eDRx configuration in which a UE (e.g., the UE 502 in FIG. 5) may be configured to target, for a wakeup, a synchronization signal (e.g., PSS and/or SSS) and a PBCH.

As illustrated in diagram 800, instances 802 of PSS/SSS with PBCH and instances 804 of PSS/SSS without PBCH may be provided to a UE from a network node (e.g., a base station, gNB, etc.) at configured subframe numbers 806. As one example, the instances 802 of PSS/SSS with PBCH may be provided to the UE every 10 subframes at the subframe numbers 806 of 10 and 20 (e.g., modulo 10), and the instances 804 of PSS/SSS without PBCH may be provided to the UE every 10 subframes at the subframe numbers 806 of 5, 15, and 25 (e.g., modulo 5). Additionally, as shown, the synchronization signals PSS/SSS, which may be the target signal(s) associated with the wakeup time 810, may thus be provided every 5 subframes of the subframe numbers 806.

In the illustrated aspect for the configuration 850, the synchronization signal(s) (e.g., PSS/SSS) and the PBCH are in a same/single subframe. An RF search period shown as a sample capture window 808, over which samples of synchronization signals/PBCH may be captured by the UE in an eDRx active mode of operation, may be utilized to search for PSS/SSS transmissions and PBCH from a network node. The sample capture window 808 may be associated with the wakeup time 810 and may start prior to or at the wakeup time 810. As one example, a low power sleep clock may have a large amount of drift that causes the actual wakeup time (e.g., the wakeup time 810) to differ from a wakeup time for a target signal by a certain amount (e.g., a threshold amount). Thus, based on the quality of the low power sleep clock, the UE may wake up at the wakeup time 810 in order to sample synchronization signals/PBCH for resynchronization. Prior to the actual wakeup time, e.g., the wakeup time 810, the UE may be in an eDRx sleep mode of operation 809.

In the configuration 850, the UE may be configured to ascertain a detection 818 of the synchronization signal(s) (e.g., PSS/SSS) and the PBCH, e.g., as target signals, for processing from the one of the instances 802 of PSS/SSS with PBCH corresponding to the subframe number 10 (although other ones of the instances 802 of PSS/SSS with PBCH may be utilized in various configurations/aspects (e.g., one corresponding to the subframe number 20)). In aspects, the UE may be configured to decode the synchronization signal(s) (e.g., PSS/SSS) and to process/decode the PBCH based on a PBCH detection indicative of a presence of the PBCH with the synchronization signal (e.g., in a same/single subframe as the synchronization signal). After the sample capture window 808 and prior to the PO 816 (and/or the TFEC 814), the UE may be configured to operate in a low power mode of operation 812, e.g., microsleep, etc., based on early termination. That is, based on the detection of at least one of the synchronization signal or the PBCH, the UE may be configured to operate in the low power mode responsive to the decode of the synchronization signal and the PBCH from the single subframe and without samples or a detection of the at least one of the synchronization signal or the PBCH based on the associated termination of the sample capture window. For example, with the detection 818 of the synchronization signal(s) (e.g., PSS/SSS) and the PBCH in the one of instances 802 of PSS/SSS with PBCH corresponding to the subframe number 10, and associated PBCH processing, the UE may be configured to determine its resynchronization with the network node and determine when the PO 816 (and/or the TFEC 814) will be transmitted, at which time the UE may enter an eDRx active mode of operation.

Thus, the duration of the sample capture window 808 may be decreased for the search for samples of synchronization signals/PBCH, while operation time in the low power mode, without additional samples based on the associated termination of the sample capture window, may be increased, and power savings may be achieved.

In the illustrated aspect for the configuration 860, the synchronization signal(s) (e.g., PSS/SSS) and the PBCH are in different subframes. An RF search period shown as a sample capture window 824, over which samples of synchronization signals/PBCH may be captured by the UE in an eDRx active mode of operation, may be utilized to search for PSS/SSS transmissions and PBCH from a network node. The sample capture window 824 may be associated with the wakeup time 810′ and may start prior to or at the wakeup time 810. As one example, a low power sleep clock may have a large amount of drift that causes the actual wakeup time (e.g., the wakeup time 810′) to differ from a wakeup time for a target signal by a certain amount (e.g., a threshold amount). Thus, based on the quality of the low power sleep clock, the UE may wake up at the wakeup time 810′ in order to sample synchronization signals/PBCH (e.g., as target signals) for resynchronization. Prior to the actual wakeup time, e.g., the wakeup time 810′, the UE may be in an eDRx sleep mode of operation 809.

In the configuration 860, the UE may be configured to ascertain detection of the synchronization signal(s) (e.g., PSS/SSS) and the PBCH for processing from the different subframes (e.g., one of the instances 802 of PSS/SSS with PBCH and one of the instances 804 of PSS/SSS without PBCH) due to clock drift. As shown, consecutive ones of the instances 802 of PSS/SSS with PBCH and the instances 804 of PSS/SSS without PBCH correspond to the subframe numbers 15 and 20 (although other ones of the instances 802 of PSS/SSS with PBCH and the instances 804 of PSS/SSS without PBCH may be utilized in various configurations/aspects).

The UE may be configured to ascertain a detection 828 of the synchronization signal(s) (e.g., PSS/SSS) from the one of the instances 804 of PSS/SSS without PBCH, which corresponds to the subframe number 15, as this may be the first one of the instances 804 of PSS/SSS without PBCH or the instances 802 of PSS/SSS with PBCH received after the wakeup time 810′. In aspects, the UE may be configured to decode the synchronization signal(s) (e.g., PSS/SSS) associated with the detection 828 thereof, during which a subframe number and/or cell identifier may be determined. After the sample capture window 824, which may end based on the detection 828, and prior to a next wakeup time 820, the UE may be configured to operate in a low power mode of operation 812′. For example, with the detection 828 of the synchronization signal(s) (e.g., PSS/SSS) in the one of instances 804 of PSS/SSS without PBCH corresponding to the subframe number 15, and associated processing, the UE may be configured to determine at least a portion of its resynchronization with the network node and determine when the next wakeup time 820 will be present, e.g., based on the synchronization signal(s) (e.g., PSS/SSS), at which time the UE may enter the low power mode of operation 812′ (e.g., microsleep and/or the like). That is, based on the detection of at least one of the synchronization signal or the PBCH, the UE may be configured to operate in the low power mode responsive to the decode of the PBCH from the second subframe and without samples or a detection of the at least one of the synchronization signal or the PBCH based on the associated termination of the sample capture window.

During a second sample capture window 826, in which the UE may be in an eDRx active mode of operation, the UE may be configured to ascertain a detection 830 of the PBCH from the one of the instances 802 of PSS/SSS with PBCH, which corresponds to the subframe number 20, as this may be the first/next one of the instances 804 of PSS/SSS without PBCH or the instances 802 of PSS/SSS with PBCH received after the detection 728 and initialization of the low power mode of operation 812′. The second sample capture window 826 may be shortened (e.g., 1 or 2 subframes in length, in aspects) based on the detection 828, which may enable the UE to determine the next wakeup time 820 for the subframe corresponding to the subframe number 20. In aspects, the UE may be configured to decode the PBCH based on a PBCH detection indicative of a presence of the PBCH with the synchronization signal (e.g., in a same/single, next subframe as the synchronization signal), during which a subframe number and/or cell identifier may be determined. After the sample capture window 826/the detection 830 (e.g., which may include the PBCH processing/decoding) and prior to the PO 816 (and/or the TFEC 814), the UE may be configured to operate in a low power mode of operation 812 (e.g., microsleep, etc.). That is, based on the detection of at least one of the synchronization signal or the PBCH, the UE may be configured to operate in the low power mode responsive to the decode of the PBCH from the second subframe and without samples or a detection of the at least one of the synchronization signal or the PBCH based on the associated termination of the sample capture window. For example, with the detection 828 of the synchronization signal(s) (e.g., PSS/SSS) and the detection 830 of the PBCH in different ones of the instances 802 of PSS/SSS with PBCH and of the instances 804 of PSS/SSS without PBCH corresponding to the subframe numbers 15 and 20, and associated PBCH processing, the UE may be configured to determine its resynchronization with the network node and determine when the PO 816 (and/or the v 814) will be transmitted, at which time the UE may enter an eDRx active mode of operation.

Thus, the duration of the sample capture windows (the sample capture window 824, the sample capture window 826) may be decreased for the search for samples of synchronization signals/PBCH, while operation time in the low power mode, without additional samples based on the associated termination of the sample capture window, may be increased, and power savings may be achieved.

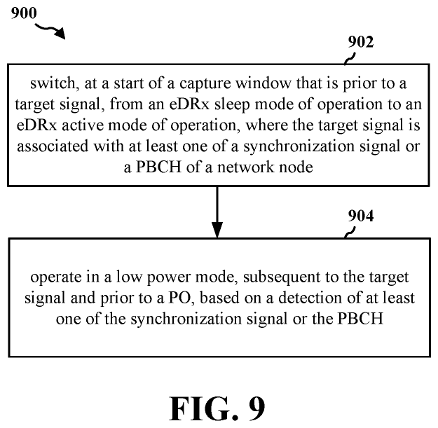

FIG. 9 is a flowchart 900 of a method of wireless communication. The method may be performed by a UE (e.g., the UE 104, 502; the apparatus 1104). In some aspects, the method may include aspects described in connection with the communication flow in FIG. 5 and/or aspects described in FIGS. 6, 7, 8, 9. The method may be for LTE eDRx search timeline optimizations. The method may provide for minimizations of eDRx search timelines and power consumption for power use to compensate for drift in low-power sleep clocks by targeting wakeup times prior to POs or pages for synchronization signal(s) and/or a PBCH, rather than the PO associated with eDRx communications.

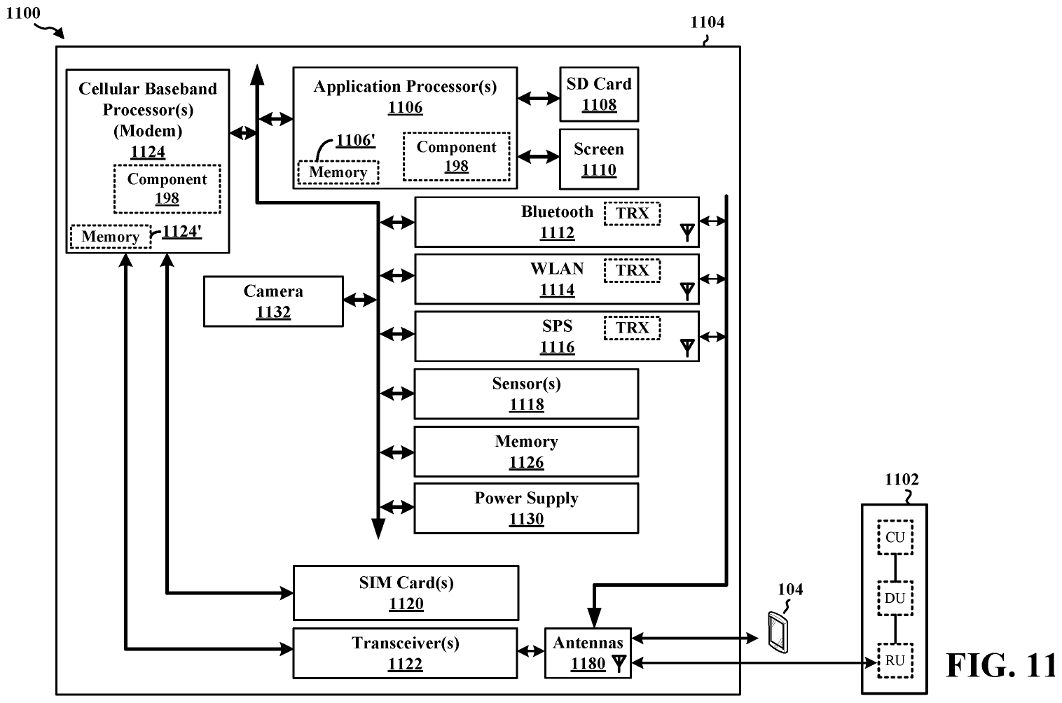

At 902, the UE switches, at a wakeup time for a start of a sample capture window that is prior to a target signal, from an eDRx sleep mode of operation to an eDRx active mode of operation, where the target signal is associated with at least one of a synchronization signal or a PBCH of a network node. As an example, the switch may be performed by one or more of the component 198, the transceiver(s) 1122, and/or the antenna 1180 in FIG. 11. FIG. 5 illustrates, in the context of FIGS. 6-9, an example of the UE 502 performing such switching between modes of operation.

The UE 502 may be configured to obtain (at 506) a wakeup time (e.g., 610 in FIG. 6; 710, 710′ in FIG. 7; 810, 810′ in FIG. 8) for the start of the sample capture window that is prior to the target signal that is associated with at least one of the synchronization signal (e.g., 602, 604 in FIG. 6; 702, 704 in FIG. 7; 802, 804 in FIG. 8) or the PBCH (e.g., 602 in FIG. 6; 702 in FIG. 7; 802 in FIG. 8). The UE 502 may be configured to calculate the wakeup time based on received parameters in signaling (e.g., RRC signaling, etc.) from the network node, in aspects, or may be configured with the wakeup time (e.g., 610 in FIG. 6; 710, 710′ in FIG. 7; 810, 810′ in FIG. 8) that may be stored in memory/in at least one memory of the UE 502 (e.g., by an OEM), from which the UE 502 may be configured to calculate/obtain (at 506) the wakeup time (e.g., 610 in FIG. 6; 710, 710′ in FIG. 7; 810, 810′ in FIG. 8). The UE 502 may be configured with the wakeup time (e.g., 610 in FIG. 6; 710, 710′ in FIG. 7; 810, 810′ in FIG. 8) by a base station such as the base station 504 through calculated/obtained (at 506) signaling (e.g., via RRC signaling, via a MAC-CE, via DCI, etc.). In aspects, the UE 502 may maintain or track the obtained wakeup time (e.g., 610 in FIG. 6; 710, 710′ in FIG. 7; 810, 810′ in FIG. 8), using a clock or a counter, based on a number of subframes, time, and/or the like. The UE 502 may be configured to receive, and the base station 504 may be configured to transmit/provide, transmissions 508 (e.g., 602, 604 in FIG. 6; 702, 704 in FIG. 7; 802, 804 in FIG. 8). In aspects, UE 502 may be configured to receive, and the base station 504 may be configured to transmit/provide, the transmissions 508 (e.g., 602, 604 in FIG. 6; 702, 704 in FIG. 7; 802, 804 in FIG. 8) as at least one of a synchronization signal (e.g., 602, 604 in FIG. 6; 702, 704 in FIG. 7; 802, 804 in FIG. 8) or a PBCH (e.g., 602 in FIG. 6; 702 in FIG. 7; 802 in FIG. 8) of a network node (e.g., the base station 504). The synchronization signal (e.g., 602, 604 in FIG. 6; 702, 704 in FIG. 7; 802, 804 in FIG. 8) may be at least one of a PSS or a SSS, in various aspects. It should be noted that the transmissions 508 (e.g., 602, 604 in FIG. 6; 702, 704 in FIG. 7; 802, 804 in FIG. 8) may be received by the UE 502, and transmitted/provided by the base station 504, one or more times in various aspects of the call flow diagram 500 (e.g., as shown in FIGS. 6, 7, 9). In aspects, at least one of the synchronization signal (e.g., 602, 604 in FIG. 6; 702, 704 in FIG. 7; 802, 804 in FIG. 8) or the PBCH (e.g., 602 in FIG. 6; 702 in FIG. 7; 802 in FIG. 8) of the transmission 508 (e.g., 602, 604 in FIG. 6; 702, 704 in FIG. 7; 802, 804 in FIG. 8) may include a cell identifier for a cell which was obtained by the UE 502 prior to the eDRx sleep mode of operation (e.g., 609 in FIG. 6; 709 in FIG. 7; 809 in FIG. 8).

The UE 502 may be configured to switch (at 510), at a wakeup time for a start of a sample capture window (608, 614, 616, in FIG. 6; 708, 714, 716, 724, 726 in FIG. 7; 808, 814, 816, 824, 826 in FIG. 8) that is prior to the target signal (e.g., 618 in FIG. 6; 718 in FIG. 7), from an eDRx sleep mode of operation (e.g., 609 in FIG. 6; 709 in FIG. 7; 809 in FIG. 8) to an eDRx active mode of operation (608, 614, 616, in FIG. 6; 708, 714, 716, 724, 726 in FIG. 7; 808, 814, 816, 824, 826 in FIG. 8). The target signal (e.g., 618 in FIG. 6; 718 in FIG. 7) may be associated with at least one of a synchronization signal (e.g., 602, 604 in FIG. 6; 702, 704 in FIG. 7; 802, 804 in FIG. 8) or a PBCH (e.g., 602 in FIG. 6; 702 in FIG. 7; 802 in FIG. 8) of the network node (e.g., the base station 504). In aspects, the eDRx active mode of operation (608, 614, 616, in FIG. 6; 708, 714, 716, 724, 726 in FIG. 7; 808, 814, 816, 824, 826 in FIG. 8) may include communications with the network node (e.g., the base station 504), such as transmissions 508 (e.g., 602, 604 in FIG. 6; 702, 704 in FIG. 7; 802, 804 in FIG. 8). In such aspects, the switch (at 510) from the eDRx sleep mode of operation (e.g., 609 in FIG. 6; 709 in FIG. 7; 809 in FIG. 8) to the eDRx active mode of operation (608, 614, 616, in FIG. 6; 708, 714, 716, 724, 726 in FIG. 7; 808, 814, 816, 824, 826 in FIG. 8) may include the switch (at 510) being based on a backoff time (e.g., 620 in FIG. 6; 720 in FIG. 7) associated with the start of the sample capture window. The backoff time (e.g., 620 in FIG. 6; 720 in FIG. 7) may be prior to the target signal (e.g., 618 in FIG. 6; 718 in FIG. 7), in aspects. The UE 502, when the target signal (e.g., 618 in FIG. 6; 718 in FIG. 7) is associated with the synchronization signal (e.g., 602, 604 in FIG. 6; 702, 704 in FIG. 7; 802, 804 in FIG. 8) (e.g., and not with the PBCH (e.g., 602 in FIG. 6; 702 in FIG. 7; 802 in FIG. 8)), may be configured to decode the synchronization signal (e.g., 602, 604 in FIG. 6; 702, 704 in FIG. 7; 802, 804 in FIG. 8) prior to operating in the low power mode. In such aspects, the UE 502 may be configured to decode the synchronization signal (e.g., 602, 604 in FIG. 6; 702, 704 in FIG. 7; 802, 804 in FIG. 8) and to decode the PBCH (e.g., 602 in FIG. 6; 702 in FIG. 7; 802 in FIG. 8) based on a PBCH detection (e.g., 622 in FIG. 6; 722, 730 in FIG. 7; 818, 830 in FIG. 8) indicative of a presence of the PBCH (e.g., 602 in FIG. 6; 702 in FIG. 7; 802 in FIG. 8) with the synchronization signal (e.g., 602, 604 in FIG. 6; 702, 704 in FIG. 7; 802, 804 in FIG. 8) (e.g., in a same/single subframe as the synchronization signal). The UE 502, when the target signal (e.g., 618 in FIG. 6; 718 in FIG. 7) is associated with the synchronization signal (e.g., 602, 604 in FIG. 6; 702, 704 in FIG. 7; 802, 804 in FIG. 8) and with the PBCH (e.g., 602 in FIG. 6; 702 in FIG. 7; 802 in FIG. 8), may be configured to decode the synchronization signal (e.g., 602, 604 in FIG. 6; 702, 704 in FIG. 7; 802, 804 in FIG. 8) and the PBCH (e.g., 602 in FIG. 6; 702 in FIG. 7; 802 in FIG. 8) prior to operating in the low power mode. In some such aspects, when the synchronization signal (e.g., 602, 604 in FIG. 6; 702, 704 in FIG. 7; 802, 804 in FIG. 8) and the PBCH (e.g., 602 in FIG. 6; 702 in FIG. 7; 802 in FIG. 8) are present in a single subframe, at least one of the synchronization signal (e.g., 602, 604 in FIG. 6; 702, 704 in FIG. 7; 802, 804 in FIG. 8) or the PBCH (e.g., 602 in FIG. 6; 702 in FIG. 7; 802 in FIG. 8) may include a cell identifier for a cell (e.g., associated with the base station 504) which was obtained by the UE 502 prior to the eDRx sleep mode of operation (e.g., 609 in FIG. 6; 709 in FIG. 7; 809 in FIG. 8), and the low power mode of operation (e.g., 612 in FIG. 6; 712, 712′ in FIG. 7; 812, 812′ in FIG. 8) may be a microsleep mode of operation based on the cell identifier.

In others of such aspects, when the synchronization signal (e.g., 602, 604 in FIG. 6; 702, 704 in FIG. 7; 802, 804 in FIG. 8) and the PBCH (e.g., 602 in FIG. 6; 702 in FIG. 7; 802 in FIG. 8) are present in different subframes, to decode the synchronization signal (e.g., 602, 604 in FIG. 6; 702, 704 in FIG. 7; 802, 804 in FIG. 8) and the PBCH (e.g., 602 in FIG. 6; 702 in FIG. 7; 802 in FIG. 8) prior to operating in the low power mode, the UE 502 may be configured to decode the synchronization signal (e.g., 602, 604 in FIG. 6; 702, 704 in FIG. 7; 802, 804 in FIG. 8) from a first subframe, to operate in the low power mode subsequent to the first subframe and prior to a second subframe that includes the PBCH (e.g., 602 in FIG. 6; 702 in FIG. 7; 802 in FIG. 8), and to decode the PBCH (e.g., 602 in FIG. 6; 702 in FIG. 7; 802 in FIG. 8) from the second subframe, for which the UE 502 may be configured to operate in the eDRx active mode of operation (608, 614, 616, in FIG. 6; 708, 714, 716, 724, 726 in FIG. 7; 808, 814, 816, 824, 826 in FIG. 8) from a start of the second subframe to after the second subframe and prior to operating in the low power mode subsequent to the target signal (e.g., 618 in FIG. 6; 718 in FIG. 7) and prior to the PO. In some such aspects, when the synchronization signal (e.g., 602, 604 in FIG. 6; 702, 704 in FIG. 7; 802, 804 in FIG. 8) and the PBCH (e.g., 602 in FIG. 6; 702 in FIG. 7; 802 in FIG. 8) are present in different subframes, at least one of the synchronization signal (e.g., 602, 604 in FIG. 6; 702, 704 in FIG. 7; 802, 804 in FIG. 8) or the PBCH (e.g., 602 in FIG. 6; 702 in FIG. 7; 802 in FIG. 8) may include a cell identifier for a cell (e.g., associated with the base station 504) which was obtained by the UE 502 prior to the eDRx sleep mode of operation (e.g., 609 in FIG. 6; 709 in FIG. 7; 809 in FIG. 8), and the low power mode of operation (e.g., 612 in FIG. 6; 712, 712′ in FIG. 7; 812, 812′ in FIG. 8) may be a microsleep mode of operation based on the cell identifier.

At 904, the UE operates in a low power mode, subsequent to the target signal and prior to a PO, based on a detection of at least one of the synchronization signal or the PBCH. As an example, the switch may be performed by one or more of the component 198, the transceiver(s) 1122, and/or the antenna 1180 in FIG. 11. FIG. 5 illustrates, in the context of FIGS. 6-9, an example of the UE 502 performing such operation in a low power mode.

The UE 502 may be configured to output an indication 512. The indication 512 may be an indication of the operation in the low power mode based on the detection (e.g., 622 in FIG. 6; 722, 728, 730 in FIG. 7; 818, 828, 830 in FIG. 8) of at least one of the synchronization signal (e.g., 602, 604 in FIG. 6; 702, 704 in FIG. 7; 802, 804 in FIG. 8) or the PBCH (e.g., 602 in FIG. 6; 702 in FIG. 7; 802 in FIG. 8). To output the indication 512, the UE 502 may be configured to transmit/provide, and the base station 504 may be configured to receive, the indication 512 via wireless transmission. In some aspects, to output the indication 512, the UE 502 may be configured to store, in memory/a memory or a cache at the UE 502, the indication 512.

The UE 502 may be configured to operate (at 514), subsequent to the target signal (e.g., 618 in FIG. 6; 718 in FIG. 7) and prior to a PO (such as a next PO after the target signal (e.g., 618 in FIG. 6; 718 in FIG. 7)), in a low power mode based on a detection (e.g., 622 in FIG. 6; 722, 728, 730 in FIG. 7; 818, 828, 830 in FIG. 8) of at least one of the synchronization signal (e.g., 602, 604 in FIG. 6; 702, 704 in FIG. 7; 802, 804 in FIG. 8) or the PBCH (e.g., 602 in FIG. 6; 702 in FIG. 7; 802 in FIG. 8). In aspects, the low power mode of operation (e.g., 612 in FIG. 6; 712, 712′ in FIG. 7; 812, 812′ in FIG. 8) in which the UE 502 may be configured to operate (at 514) may be at least one of the eDRx sleep mode of operation (e.g., 609 in FIG. 6; 709 in FIG. 7; 809 in FIG. 8), an extended low power mode of operation, or a microsleep mode of operation.

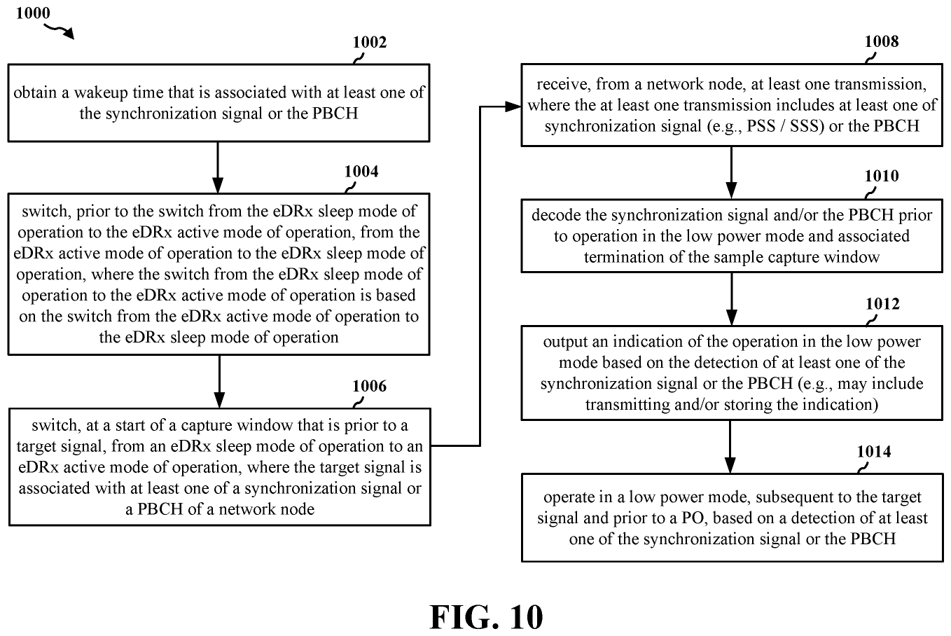

FIG. 10 is a flowchart 1000 of a method of wireless communication. The method may be performed by a UE (e.g., the UE 104, 502; the apparatus 1104). In some aspects, the method may include aspects described in connection with the communication flow in FIG. 5 and/or aspects described in FIGS. 6, 7, 8, 9. The method may be for LTE eDRx search timeline optimizations. The method may provide for minimizations of eDRx search timelines and power consumption for power use to compensate for drift in low-power sleep clocks by targeting wakeup times prior to POs or pages for synchronization signal(s) and/or a PBCH, rather than the PO associated with eDRx communications.

At 1002, the UE obtains a wakeup time for the start of the sample capture window that is prior to the target signal that is associated with at least one of the synchronization signal or the PBCH. As an example, the obtainment may be performed by one or more of the component 198, the transceiver(s) 1122, and/or the antenna 1180 in FIG. 11. FIG. 5 illustrates, in the context of FIGS. 6-9, an example of the UE 502 performing such obtainment of a wakeup time.

The UE 502 may be configured to obtain (at 506) a wakeup time (e.g., 610 in FIG. 6; 710, 710′ in FIG. 7; 810, 810′ in FIG. 8) for the start of the sample capture window that is prior to the target signal that is associated with at least one of the synchronization signal (e.g., 602, 604 in FIG. 6; 702, 704 in FIG. 7; 802, 804 in FIG. 8) or the PBCH (e.g., 602 in FIG. 6; 702 in FIG. 7; 802 in FIG. 8). The UE 502 may be configured to calculate the wakeup time based on received parameters in signaling (e.g., RRC signaling, etc.) from the network node, in aspects, or may be configured with the wakeup time (e.g., 610 in FIG. 6; 710, 710′ in FIG. 7; 810, 810′ in FIG. 8) that may be stored in memory/in at least one memory of the UE 502 (e.g., by an OEM), from which the UE 502 may be configured to calculate/obtain (at 506) the wakeup time (e.g., 610 in FIG. 6; 710, 710′ in FIG. 7; 810, 810′ in FIG. 8). The UE 502 may be configured with the wakeup time (e.g., 610 in FIG. 6; 710, 710′ in FIG. 7; 810, 810′ in FIG. 8) by a base station such as the base station 504 through calculated/obtained (at 506) signaling (e.g., via RRC signaling, via a MAC-CE, via DCI, etc.). In aspects, the UE 502 may maintain or track the obtained wakeup time (e.g., 610 in FIG. 6; 710, 710′ in FIG. 7; 810, 810′ in FIG. 8), using a clock or a counter, based on a number of subframes, time, and/or the like.

At 1004, the UE switches, prior to the switch from the eDRx sleep mode of operation to the eDRx active mode of operation, from the eDRx active mode of operation to the eDRx sleep mode of operation, where the switch from the eDRx sleep mode of operation to the eDRx active mode of operation is based on the switch from the eDRx active mode of operation to the eDRx sleep mode of operation. As an example, the switch may be performed by one or more of the component 198, the transceiver(s) 1122, and/or the antenna 1180 in FIG. 11. FIG. 5 illustrates, in the context of FIGS. 6-9, an example of the UE 502 performing such switching between modes of operation.

The UE 502 may be configured to switch from an initial eDRx active mode to the eDRx sleep mode (e.g., 609 in FIG. 6; 709 in FIG. 7; 809 in FIG. 8). In aspects, at least one of the synchronization signal (e.g., 602, 604 in FIG. 6; 702, 704 in FIG. 7; 802, 804 in FIG. 8) or the PBCH (e.g., 602 in FIG. 6; 702 in FIG. 7; 802 in FIG. 8) of the transmission 508 (e.g., 602, 604 in FIG. 6; 702, 704 in FIG. 7; 802, 804 in FIG. 8) may include a cell identifier for a cell which was obtained by the UE 502 prior to the eDRx sleep mode of operation (e.g., 609 in FIG. 6; 709 in FIG. 7; 809 in FIG. 8), such as while in the an initial eDRx active mode (e.g., a prior instance of 614, 616 in FIG. 6; a prior instance of 714, 716 in FIG. 7; a prior instance of 814, 816 in FIG. 8).

At 1006, the UE switches, at a start of a sample capture window that is prior to a target wakeup time, from an eDRx sleep mode of operation to an eDRx active mode of operation, where the target wakeup time is associated with at least one of a synchronization signal or a PBCH of a network node. As an example, the switch may be performed by one or more of the component 198, the transceiver(s) 1122, and/or the antenna 1180 in FIG. 11. FIG. 5 illustrates, in the context of FIGS. 6-9, an example of the UE 502 performing such switching between modes of operation.

The UE 502 may be configured to switch (at 510), at a wakeup time for a start of a sample capture window (608, 614, 616, in FIG. 6; 708, 714, 716, 724, 726 in FIG. 7; 808, 814, 816, 824, 826 in FIG. 8) that is prior to the target signal (e.g., 618 in FIG. 6; 718 in FIG. 7), from an eDRx sleep mode of operation (e.g., 609 in FIG. 6; 709 in FIG. 7; 809 in FIG. 8) to an eDRx active mode of operation (608, 614, 616, in FIG. 6; 708, 714, 716, 724, 726 in FIG. 7; 808, 814, 816, 824, 826 in FIG. 8). The target signal (e.g., 618 in FIG. 6; 718 in FIG. 7) may be associated with at least one of a synchronization signal (e.g., 602, 604 in FIG. 6; 702, 704 in FIG. 7; 802, 804 in FIG. 8) or a PBCH (e.g., 602 in FIG. 6; 702 in FIG. 7; 802 in FIG. 8) of the network node (e.g., the base station 504). In aspects, the eDRx active mode of operation (608, 614, 616, in FIG. 6; 708, 714, 716, 724, 726 in FIG. 7; 808, 814, 816, 824, 826 in FIG. 8) may include communications with the network node (e.g., the base station 504), such as transmissions 508 (e.g., 602, 604 in FIG. 6; 702, 704 in FIG. 7; 802, 804 in FIG. 8). In such aspects, the switch (at 510) from the eDRx sleep mode of operation (e.g., 609 in FIG. 6; 709 in FIG. 7; 809 in FIG. 8) to the eDRx active mode of operation (608, 614, 616, in FIG. 6; 708, 714, 716, 724, 726 in FIG. 7; 808, 814, 816, 824, 826 in FIG. 8) may include the switch (at 510) being based on a backoff time (e.g., 620 in FIG. 6; 720 in FIG. 7) associated with the start of the sample capture window. The backoff time (e.g., 620 in FIG. 6; 720 in FIG. 7) may be prior to the target signal (e.g., 618 in FIG. 6; 718 in FIG. 7), in aspects.

At 1008, the UE receives, from a network node, at least one transmission, where the at least one transmission includes at least one of synchronization signal (e.g., PSS/SSS) or the PBCH. As an example, the reception may be performed by one or more of the component 198, the transceiver(s) 1122, and/or the antenna 1180 in FIG. 11. FIG. 5 illustrates, in the context of FIGS. 6-9, an example of the UE 502 receiving such a transmission(s) form a network node (e.g., the base station 504).

In aspects, UE 502 may be configured to receive, and the base station 504 may be configured to transmit/provide, the transmissions 508 (e.g., 602, 604 in FIG. 6; 702, 704 in FIG. 7; 802, 804 in FIG. 8) as at least one of a synchronization signal (e.g., 602, 604 in FIG. 6; 702, 704 in FIG. 7; 802, 804 in FIG. 8) or a PBCH (e.g., 602 in FIG. 6; 702 in FIG. 7; 802 in FIG. 8) of a network node (e.g., the base station 504). The synchronization signal (e.g., 602, 604 in FIG. 6; 702, 704 in FIG. 7; 802, 804 in FIG. 8) may be at least one of a PSS or a SSS, in various aspects. It should be noted that the transmissions 508 (e.g., 602, 604 in FIG. 6; 702, 704 in FIG. 7; 802, 804 in FIG. 8) may be received by the UE 502, and transmitted/provided by the base station 504, one or more times in various aspects of the call flow diagram 500 (e.g., as shown in FIGS. 6, 7, 9). In aspects, at least one of the synchronization signal (e.g., 602, 604 in FIG. 6; 702, 704 in FIG. 7; 802, 804 in FIG. 8) or the PBCH (e.g., 602 in FIG. 6; 702 in FIG. 7; 802 in FIG. 8) of the transmission 508 (e.g., 602, 604 in FIG. 6; 702, 704 in FIG. 7; 802, 804 in FIG. 8) may include a cell identifier for a cell which was obtained by the UE 502 prior to the eDRx sleep mode of operation (e.g., 609 in FIG. 6; 709 in FIG. 7; 809 in FIG. 8).

At 1010, the UE decodes the synchronization signal and/or the PBCH prior to operating in the low power mode. As an example, the decode may be performed by one or more of the component 198, the transceiver(s) 1122, and/or the antenna 1180 in FIG. 11. FIG. 5 illustrates, in the context of FIGS. 6-9, an example of the UE 502 decoding such synchronization signal and/or the PBCH form a network node (e.g., the base station 504).

The UE 502, when the target signal (e.g., 618 in FIG. 6; 718 in FIG. 7) is associated with the synchronization signal (e.g., 602, 604 in FIG. 6; 702, 704 in FIG. 7; 802, 804 in FIG. 8) (e.g., and not with the PBCH (e.g., 602 in FIG. 6; 702 in FIG. 7; 802 in FIG. 8)), may be configured to decode the synchronization signal (e.g., 602, 604 in FIG. 6; 702, 704 in FIG. 7; 802, 804 in FIG. 8) prior to operating in the low power mode. In such aspects, the UE 502 may be configured to decode the synchronization signal (e.g., 602, 604 in FIG. 6; 702, 704 in FIG. 7; 802, 804 in FIG. 8) and to decode the PBCH (e.g., 602 in FIG. 6; 702 in FIG. 7; 802 in FIG. 8) based on a PBCH detection (e.g., 622 in FIG. 6; 722, 730 in FIG. 7; 818, 830 in FIG. 8) indicative of a presence of the PBCH (e.g., 602 in FIG. 6; 702 in FIG. 7; 802 in FIG. 8) with the synchronization signal (e.g., 602, 604 in FIG. 6; 702, 704 in FIG. 7; 802, 804 in FIG. 8) (e.g., in a same/single subframe as the synchronization signal). The UE 502, when the target signal (e.g., 618 in FIG. 6; 718 in FIG. 7) is associated with the synchronization signal (e.g., 602, 604 in FIG. 6; 702, 704 in FIG. 7; 802, 804 in FIG. 8) and with the PBCH (e.g., 602 in FIG. 6; 702 in FIG. 7; 802 in FIG. 8), may be configured to decode the synchronization signal (e.g., 602, 604 in FIG. 6; 702, 704 in FIG. 7; 802, 804 in FIG. 8) and the PBCH (e.g., 602 in FIG. 6; 702 in FIG. 7; 802 in FIG. 8) prior to operating in the low power mode. In some such aspects, when the synchronization signal (e.g., 602, 604 in FIG. 6; 702, 704 in FIG. 7; 802, 804 in FIG. 8) and the PBCH (e.g., 602 in FIG. 6; 702 in FIG. 7; 802 in FIG. 8) are present in a single subframe, at least one of the synchronization signal (e.g., 602, 604 in FIG. 6; 702, 704 in FIG. 7; 802, 804 in FIG. 8) or the PBCH (e.g., 602 in FIG. 6; 702 in FIG. 7; 802 in FIG. 8) may include a cell identifier for a cell (e.g., associated with the base station 504) which was obtained by the UE 502 prior to the eDRx sleep mode of operation (e.g., 609 in FIG. 6; 709 in FIG. 7; 809 in FIG. 8), and the low power mode of operation (e.g., 612 in FIG. 6; 712, 712′ in FIG. 7; 812, 812′ in FIG. 8) may be a microsleep mode of operation based on the cell identifier.

In others of such aspects, when the synchronization signal (e.g., 602, 604 in FIG. 6; 702, 704 in FIG. 7; 802, 804 in FIG. 8) and the PBCH (e.g., 602 in FIG. 6; 702 in FIG. 7; 802 in FIG. 8) are present in different subframes, to decode the synchronization signal (e.g., 602, 604 in FIG. 6; 702, 704 in FIG. 7; 802, 804 in FIG. 8) and the PBCH (e.g., 602 in FIG. 6; 702 in FIG. 7; 802 in FIG. 8) prior to operating in the low power mode, the UE 502 may be configured to decode the synchronization signal (e.g., 602, 604 in FIG. 6; 702, 704 in FIG. 7; 802, 804 in FIG. 8) from a first subframe, to operate in the low power mode subsequent to the first subframe and prior to a second subframe that includes the PBCH (e.g., 602 in FIG. 6; 702 in FIG. 7; 802 in FIG. 8), and to decode the PBCH (e.g., 602 in FIG. 6; 702 in FIG. 7; 802 in FIG. 8) from the second subframe, for which the UE 502 may be configured to operate in the eDRx active mode of operation (608, 614, 616, in FIG. 6; 708, 714, 716, 724, 726 in FIG. 7; 808, 814, 816, 824, 826 in FIG. 8) from a start of the second s subframe lot to after the second subframe and prior to operating in the low power mode subsequent to the target signal (e.g., 618 in FIG. 6; 718 in FIG. 7) and prior to the PO. In some such aspects, when the synchronization signal (e.g., 602, 604 in FIG. 6; 702, 704 in FIG. 7; 802, 804 in FIG. 8) and the PBCH (e.g., 602 in FIG. 6; 702 in FIG. 7; 802 in FIG. 8) are present in different subframes, at least one of the synchronization signal (e.g., 602, 604 in FIG. 6; 702, 704 in FIG. 7; 802, 804 in FIG. 8) or the PBCH (e.g., 602 in FIG. 6; 702 in FIG. 7; 802 in FIG. 8) may include a cell identifier for a cell (e.g., associated with the base station 504) which was obtained by the UE 502 prior to the eDRx sleep mode of operation (e.g., 609 in FIG. 6; 709 in FIG. 7; 809 in FIG. 8), and the low power mode of operation (e.g., 612 in FIG. 6; 712, 712′ in FIG. 7; 812, 812′ in FIG. 8) may be a microsleep mode of operation based on the cell identifier.

At, 1012, the UE outputs an indication of the operation in the low power mode based on the detection of at least one of the synchronization signal or the PBCH (e.g., may include transmitting and/or storing the indication). As an example, the output may be performed by one or more of the component 198, the transceiver(s) 1122, and/or the antenna 1180 in FIG. 11. FIG. 5 illustrates, in the context of FIGS. 6-9, an example of the UE 502 outputting such synchronization signal and/or the PBCH for a memory/cache of the UE 502 and/or for a network node (e.g., the base station 504).

The UE 502 may be configured to output an indication 512. The indication 512 may be an indication of the operation in the low power mode based on the detection (e.g., 622 in FIG. 6; 722, 728, 730 in FIG. 7; 818, 828, 830 in FIG. 8) of at least one of the synchronization signal (e.g., 602, 604 in FIG. 6; 702, 704 in FIG. 7; 802, 804 in FIG. 8) or the PBCH (e.g., 602 in FIG. 6; 702 in FIG. 7; 802 in FIG. 8). To output the indication 512, the UE 502 may be configured to transmit/provide, and the base station 504 may be configured to receive, the indication 512 via wireless transmission. In some aspects, to output the indication 512, the UE 502 may be configured to store, in memory/a memory or a cache at the UE 502, the indication 512.

At 1014, the UE operates in a low power mode, subsequent to the target signal and prior to a PO, based on a detection of at least one of the synchronization signal or the PBCH. As an example, the switch may be performed by one or more of the component 198, the transceiver(s) 1122, and/or the antenna 1180 in FIG. 11. FIG. 5 illustrates, in the context of FIGS. 6-9, an example of the UE 502 performing such operation in a low power mode.

The UE 502 may be configured to operate (at 514), subsequent to the target signal (e.g., 618 in FIG. 6; 718 in FIG. 7) and prior to a PO (such as a next PO after the target signal (e.g., 618 in FIG. 6; 718 in FIG. 7)), in a low power mode based on a detection (e.g., 622 in FIG. 6; 722, 728, 730 in FIG. 7; 818, 828, 830 in FIG. 8) of at least one of the synchronization signal (e.g., 602, 604 in FIG. 6; 702, 704 in FIG. 7; 802, 804 in FIG. 8) or the PBCH (e.g., 602 in FIG. 6; 702 in FIG. 7; 802 in FIG. 8). In aspects, the low power mode of operation (e.g., 612 in FIG. 6; 712, 712′ in FIG. 7; 812, 812′ in FIG. 8) in which the UE 502 may be configured to operate (at 514) may be at least one of the eDRx sleep mode of operation (e.g., 609 in FIG. 6; 709 in FIG. 7; 809 in FIG. 8), an extended low power mode of operation, or a microsleep mode of operation.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) 1124 communicates through the transceiver(s) 1122 via one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The cellular baseband processor(s) 1124 and the application processor(s) 1106 are configured to perform the various functions described supra based at least in part of the information stored in the memory. That is, the cellular baseband processor(s) 1124 and the application processor(s) 1106 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the component 198 may be configured to switch, at a start of a sample capture window that is prior to a target wakeup time, from an eDRx sleep mode of operation to an eDRx active mode of operation, where the target wakeup time is associated with at least one of a synchronization signal or a PBCH of a network node. The component 198 may also be configured to operate, subsequent to the target wakeup time and prior to a PO, in a low power mode based on a detection of at least one of the synchronization signal or the PBCH. The component 198 may be configured to obtain the wakeup time for the start of the sample capture window that is prior to the target signal that is associated with at least one of the synchronization signal or the PBCH, where the synchronization signal is at least one of a primary synchronization signal (PSS) or a secondary synchronization signal (SSS). The component 198 may be configured to decode the synchronization signal prior to operation in the low power mode and an associated termination of the sample capture window. The component 198 may be configured to decode the synchronization signal and the PBCH prior to operation in the low power mode and an associated termination of the sample capture window. The component 198 may be configured to switch, prior to the switch from the eDRx sleep mode of operation to the eDRx active mode of operation, from the eDRx active mode of operation to the eDRx sleep mode of operation, where the switch from the eDRx sleep mode of operation to the eDRx active mode of operation is based on the switch from the eDRx active mode of operation to the eDRx sleep mode of operation. The component 198 may be configured to output an indication of the operation in the low power mode based on the detection of at least one of the synchronization signal or the PBCH. The component 198 may be configured to receive, from the network node via the transceiver, at least one transmission, where the at least one transmission includes at least one of the synchronization signal or the PBCH. The component 198 may be further configured to perform any of the aspects described in connection with the flowcharts in any of FIGS. 9, 11 and/or any of the aspects performed by a UE for any of FIGS. 5-9. The component 198 may be within the cellular baseband processor(s) 1124, the application processor(s) 1106, or both the cellular baseband processor(s) 1124 and the application processor(s) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for switching, at a start of a sample capture window that is prior to a target wakeup time, from an eDRx sleep mode of operation to an eDRx active mode of operation, where the target wakeup time is associated with at least one of a synchronization signal or a PBCH of a network node. In the configuration, the apparatus 1104, and in particular the cellular baseband processor(s) 1124 and/or the application processor(s) 1106, may include means for operating, subsequent to the target wakeup time and prior to a PO, in a low power mode based on a detection of at least one of the synchronization signal or the PBCH. In one configuration, the apparatus 1104, and in particular the cellular baseband processor(s) 1124 and/or the application processor(s) 1106, may include means for obtaining the wakeup time for the start of the sample capture window that is prior to the target signal that is associated with at least one of the synchronization signal or the PBCH, where the synchronization signal is at least one of a PSS or a SSS. In one configuration, the apparatus 1104, and in particular the cellular baseband processor(s) 1124 and/or the application processor(s) 1106, may include means for decoding the synchronization signal prior to operation in the low power mode and an associated termination of the sample capture window. In one configuration, the apparatus 1104, and in particular the cellular baseband processor(s) 1124 and/or the application processor(s) 1106, may include means for decoding the synchronization signal and the PBCH prior to operation in the low power mode and an associated termination of the sample capture window. In one configuration, the apparatus 1104, and in particular the cellular baseband processor(s) 1124 and/or the application processor(s) 1106, may include means for switching, prior to the switch from the eDRx sleep mode of operation to the eDRx active mode of operation, from the eDRx active mode of operation to the eDRx sleep mode of operation, where the switch from the eDRx sleep mode of operation to the eDRx active mode of operation is based on the switch from the eDRx active mode of operation to the eDRx sleep mode of operation. In one configuration, the apparatus 1104, and in particular the cellular baseband processor(s) 1124 and/or the application processor(s) 1106, may include means for outputting an indication of the operation in the low power mode based on the detection of at least one of the synchronization signal or the PBCH. In one configuration, the apparatus 1104, and in particular the cellular baseband processor(s) 1124 and/or the application processor(s) 1106, may include means for receiving, from the network node via the transceiver, at least one transmission, where the at least one transmission includes at least one of the synchronization signal or the PBCH. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

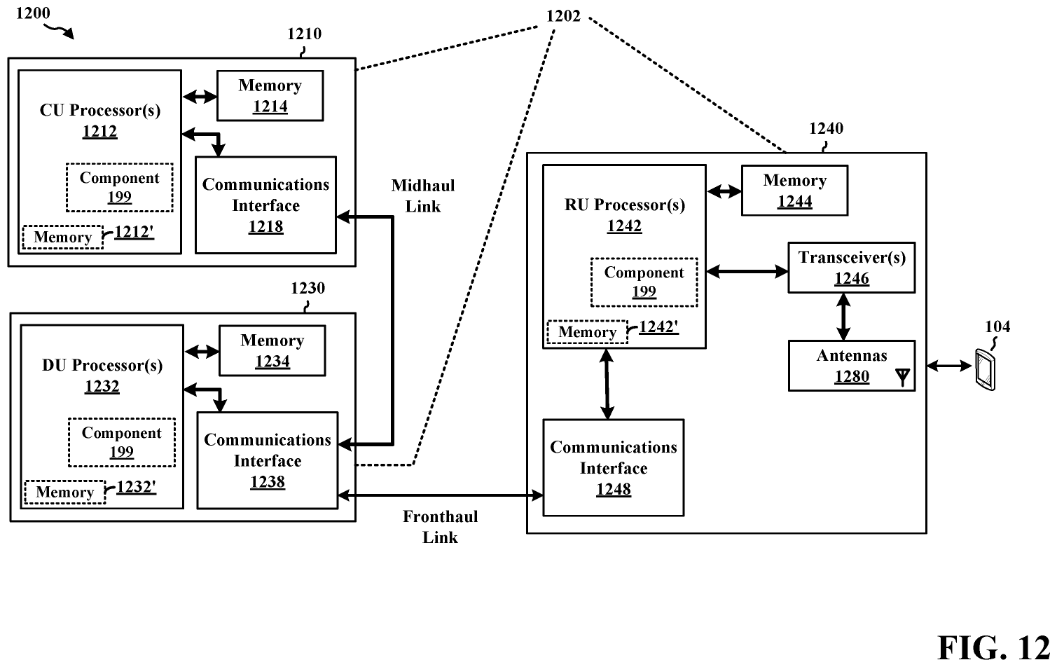

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor(s) 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor(s) 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor(s) 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to provide, for a UE, a target signal that is associated with at least one of a synchronization signal or a PBCH, where the synchronization signal is at least one of a primary synchronization signal (PSS) or a secondary synchronization signal (SSS). The component 199 may be configured to transmit, for the UE, at least one of the synchronization signal or the PBCH. The component 199 may be configured to receive, from the UE, an indication of an operation in a low power mode at the UE based on a detection of at least one of the synchronization signal or the PBCH by the UE. The component 199 may be further configured to perform any of the aspects described in connection with the flowcharts in any of FIGS. 9, 11 and/or any of the aspects performed by a network node, base station, gNB, etc., for any of FIGS. 5-9. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 may include means for providing, for a UE, a target wakeup time that is associated with at least one of a synchronization signal or a PBCH, where the synchronization signal is at least one of a primary synchronization signal (PSS) or a secondary synchronization signal (SSS). In one configuration, the network entity 1202 may include means for transmitting, for the UE, at least one of the synchronization signal or the PBCH. In one configuration, the network entity 1202 may include means for receiving, from the UE, an indication of an operation in the low power mode at the UE based on a detection of at least one of the synchronization signal or the PBCH by the UE. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

A network node and a UE in a wireless communication network may communicate in various configurations and using various communication schema to conserve power. One example communication scheme to conserve power is DRx. Another example communication scheme to conserve power is eDRx for IoT devices. In various implementations for IoT devices, eDRx power may be a KPI of these platforms. For instance, implementations with stringent power targets (e.g., ˜10 uA at the battery) under tight cost constraints and competitive pressure, may utilize eDRx to meet such targets. However, an IoT architecture and/or a RTOS application that implements eDRx may incur other performance impacts to achieve power savings. As one example, a low-power sleep clock may be used to bring power down, but may come at the cost of high clock error/drift (e.g., 40-250 ppm). As an IoT device loses its time synchronization with the network during sleep due to clock drift, the device may perform a search in order to re-synchronize with the network upon waking up. In such cases, a larger clock drift that is realized during low power periods to conserve power may lead to longer and more power intensive searches for the re-synchronization with the network, which adversely impacts power savings.

The aspects herein for LTE eDRx search timeline optimizations enable a UE to minimize eDRx search timelines and power consumption for power use to compensate for drift in low-power sleep clocks. A UE may be configured to target signals prior to paging offsets POs or pages for wakeup times, e.g., by targeting a synchronization signal(s) and/or a PBCH, rather than the PO associated with eDRx communications. Aspects herein enable minimization of eDRx search timelines and power consumption for power use to compensate for drift in low-power sleep clocks by targeting a synchronization signal(s)/a PBCH, rather than the PO associated with eDRx communications. Aspects also provide for further reductions in power consumption by implementing low power modes between synchronization signals and a PBCH in different subframes. Aspect also provide for still further reductions in power consumption by performing early termination of searches for re-synchronization.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: switching, at a wakeup time for a start of a sample capture window that is prior to a target signal, from an extended discontinuous reception (eDRx) sleep mode of operation to an eDRx active mode of operation, wherein the target signal is associated with at least one of a synchronization signal or a physical broadcast channel (PBCH) of a network node; and operating, subsequent to the target signal and prior to a paging occasion (PO), in a low power mode based on a detection of at least one of the synchronization signal or the PBCH.

Aspect 2 is the method of aspect 1, further comprising: obtaining the wakeup time for the start of the sample capture window that is prior to the target signal that is associated with at least one of the synchronization signal or the PBCH, wherein the synchronization signal is at least one of a primary synchronization signal (PSS) or a secondary synchronization signal (SSS).

Aspect 3 is the method of any of aspects 1 and 2, wherein the eDRx active mode of operation includes communications with the network node, wherein switching from the eDRx sleep mode of operation to the eDRx active mode of operation includes switching based on the start of the sample capture window associated with a backoff time, wherein the backoff time is prior to the target signal.

Aspect 4 is the method of any of aspects 1 to 3, wherein the target signal is associated with the synchronization signal, wherein the method further comprises: decoding the synchronization signal prior to operating in the low power mode and an associated termination of the sample capture window.

Aspect 5 is the method of aspect 4, wherein decoding the synchronization signal includes decoding the PBCH based on a PBCH decoding indicative of a presence of the PBCH with the synchronization signal.

Aspect 6 is the method of any of aspects 1 to 3, wherein the target signal is associated with the synchronization signal and the PBCH, wherein the method further comprises: decoding the synchronization signal and the PBCH prior to operating in the low power mode and an associated termination of the sample capture window.

Aspect 7 is the method of aspect 6, wherein the synchronization signal and the PBCH are present in a single subframe; wherein at least one of the synchronization signal or the PBCH includes a cell identifier for a cell which was obtained by the UE prior to the eDRx sleep mode of operation; wherein to operate in the low power mode based on the detection of at least one of the synchronization signal or the PBCH, the at least one processor is configured to operate in the low power mode responsive to the decode of the synchronization signal and the PBCH from the single subframe and without samples or a detection of the at least one of the synchronization signal or the PBCH based on the associated termination of the sample capture window.

Aspect 8 is the method of aspect 6, wherein the synchronization signal and the PBCH are present in different subframes, wherein decoding the synchronization signal and the PBCH prior to operating in the low power mode includes: decoding the synchronization signal from a first subframe; operating in the low power mode subsequent to the first subframe and prior to a second subframe that includes the PBCH; and decoding the PBCH from the second subframe prior to operating in the low power mode subsequent to the target signal and prior to the PO.

Aspect 9 is the method of aspect 8, wherein at least one of the synchronization signal or the PBCH includes a cell identifier for a cell which was obtained by the UE prior to the eDRx sleep mode of operation; wherein to operate in the low power mode, the at least one processor is configured to operate in the low power mode responsive to the decode of the synchronization signal and the PBCH from the different subframes and without samples or a detection of the at least one of the synchronization signal or the PBCH based on the associated termination of the sample capture window.

Aspect 10 is the method of any of aspects 1 to 9, wherein the UE is an Internet of Things (IoT) device or a wireless device.

Aspect 11 is the method of any of aspects 1 to 10, wherein the low power mode of operation is at least one of the eDRx sleep mode of operation, an extended low power mode of operation, or a microsleep mode of operation, and is based on an associated termination of the sample capture window.

Aspect 12 is the method of any of aspects 1 to 11, further comprising: switching, prior to the switch from the eDRx sleep mode of operation to the eDRx active mode of operation, from the eDRx active mode of operation to the eDRx sleep mode of operation, wherein the switch from the eDRx sleep mode of operation to the eDRx active mode of operation is based on the switch from the eDRx active mode of operation to the eDRx sleep mode of operation.

Aspect 13 is the method of any of aspects 1 to 12, further comprising: outputting an indication of the operation in the low power mode based on the detection of at least one of the synchronization signal or the PBCH.

Aspect 14 is the method of aspect 13, wherein outputting the indication of the operation in the low power mode based on the detection of at least one of the synchronization signal or the PBCH comprises: storing, in a memory or a cache at the UE, the indication of the operation in the low power mode based on the detection of at least one of the synchronization signal or the PBCH.

Aspect 15 is the method of aspect 13, further comprising: receiving, from the network node via the transceiver, at least one transmission, wherein the at least one transmission includes at least one of the synchronization signal or the PBCH.

Aspect 16 is an apparatus for wireless communication at a user equipment (UE), comprising: at least one memory; and at least one processor coupled to the at least one memory, the at least one processor, individually or in any combination, is configured to perform the method of any of aspects 1 to 15.

Aspect 17 is an apparatus for wireless communication at a user equipment (UE), comprising means for performing each step in the method of any of aspects 1 to 15.

Aspect 18 is the apparatus of any of aspects 16 and 17, further comprising a transceiver configured to receive or to transmit in association with the method of any of aspects 1 to 15.

Aspect 19 is a computer-readable medium (e.g., a non-transitory computer-readable medium) storing computer executable code a user equipment (UE), the code when executed by at least one processor causes the UE to perform the method of any of aspects 1 to 15.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
switch, at a wakeup time for a start of a sample capture window that is prior to a target signal, from an extended discontinuous reception (eDRx) sleep mode of operation to an eDRx active mode of operation, wherein the target signal is associated with at least one of a synchronization signal or a physical broadcast channel (PBCH) of a network node; and
operate, subsequent to the target signal and prior to a paging occasion (PO), in a low power mode based on a detection of at least one of the synchronization signal or the PBCH.

2. The apparatus of claim 1, wherein the at least one processor, individually or in any combination, is further configured to:
obtain the wakeup time for the start of the sample capture window that is prior to the target signal that is associated with at least one of the synchronization signal or the PBCH, wherein the synchronization signal is at least one of a primary synchronization signal (PSS) or a secondary synchronization signal (SSS).

3. The apparatus of claim 1, wherein the eDRx active mode of operation includes communications with the network node, wherein to switch from the eDRx sleep mode of operation to the eDRx active mode of operation, the at least one processor, individually or in any combination, is configured to switch based on the start of the sample capture window associated with a backoff time, wherein the backoff time is prior to the target signal.

4. The apparatus of claim 1, wherein the target signal is associated with the synchronization signal, wherein the at least one processor, individually or in any combination, is further configured to:
decode the synchronization signal prior to operation in the low power mode and an associated termination of the sample capture window.

5. The apparatus of claim 4, wherein to decode the synchronization signal, the at least one processor, individually or in any combination, is configured to decode the PBCH based on a PBCH decoding indicative of a presence of the PBCH with the synchronization signal.

6. The apparatus of claim 1, wherein the target signal is associated with the synchronization signal and the PBCH, wherein the at least one processor, individually or in any combination, is further configured to:
decode the synchronization signal and the PBCH prior to operation in the low power mode and an associated termination of the sample capture window.

7. The apparatus of claim 6, wherein the synchronization signal and the PBCH are present in a single subframe;
wherein at least one of the synchronization signal or the PBCH includes a cell identifier for a cell which was obtained by the UE prior to the eDRx sleep mode of operation;
wherein to operate in the low power mode based on the detection of at least one of the synchronization signal or the PBCH, the at least one processor is configured to operate in the low power mode responsive to the decode of the synchronization signal and the PBCH from the single subframe and without samples or a detection of the at least one of the synchronization signal or the PBCH based on the associated termination of the sample capture window.

8. The apparatus of claim 6, wherein the synchronization signal and the PBCH are present in different subframes, wherein to decode the synchronization signal and the PBCH prior to operation in the low power mode, the at least one processor, individually or in any combination, is configured to:
decode the synchronization signal from a first subframe;
operate in the low power mode subsequent to the first subframe and prior to a second subframe that includes the PBCH; and
decode the PBCH from the second subframe prior to operation in the low power mode subsequent to the target signal and prior to the PO.

9. The apparatus of claim 8, wherein at least one of the synchronization signal or the PBCH includes a cell identifier for a cell which was obtained by the UE prior to the eDRx sleep mode of operation;
wherein to operate in the low power mode, the at least one processor is configured to operate in the low power mode responsive to the decode of the synchronization signal and the PBCH from the different subframe and without samples or a detection of the at least one of the synchronization signal or the PBCH based on the associated termination of the sample capture window.

10. The apparatus of claim 1, wherein the UE is an Internet of Things (IoT) device or a wireless device.

11. The apparatus of claim 1, wherein the low power mode is at least one of the eDRx sleep mode of operation, an extended low power mode of operation, or a microsleep mode of operation, and is based on an associated termination of the sample capture window.

12. The apparatus of claim 1, wherein the at least one processor, individually or in any combination, is further configured to:
switch, prior to the switch from the eDRx sleep mode of operation to the eDRx active mode of operation, from the eDRx active mode of operation to the eDRx sleep mode of operation, wherein the switch from the eDRx sleep mode of operation to the eDRx active mode of operation is based on the switch from the eDRx active mode of operation to the eDRx sleep mode of operation.

13. The apparatus of claim 1, wherein the at least one processor, individually or in any combination, is further configured to:
output an indication of the operation in the low power mode based on the detection of at least one of the synchronization signal or the PBCH.

14. The apparatus of claim 13, wherein to output the indication of the operation in the low power mode based on the detection of at least one of the synchronization signal or the PBCH, the at least one processor, individually or in any combination, is configured to:
store, in a memory or a cache at the UE, the indication of the operation in the low power mode based on the detection of at least one of the synchronization signal or the PBCH.

15. The apparatus of claim 1, further comprising a transceiver coupled to the at least one processor, wherein the at least one processor, individually or in any combination, is further configured to:
receive, from the network node via the transceiver, at least one transmission, wherein the at least one transmission includes at least one of the synchronization signal or the PBCH.

16. A method of wireless communication at a user equipment (UE), comprising:
switching, at a wakeup time for a start of a sample capture window that is prior to a target signal, from an extended discontinuous reception (eDRx) sleep mode of operation to an eDRx active mode of operation, wherein the target signal is associated with at least one of a synchronization signal or a physical broadcast channel (PBCH) of a network node; and
operating, subsequent to the target signal and prior to a paging occasion (PO), in a low power mode based on a detection of at least one of the synchronization signal or the PBCH.

17. The method of claim 16, further comprising:
obtaining the wakeup time for the start of the sample capture window that is prior to the target signal that is associated with at least one of the synchronization signal or the PBCH, wherein the synchronization signal is at least one of a primary synchronization signal (PSS) or a secondary synchronization signal (SSS).

18. The method of claim 16, wherein the eDRx active mode of operation includes communications with the network node, wherein switching from the eDRx sleep mode of operation to the eDRx active mode of operation includes switching based on the start of the sample capture window associated with a backoff time, wherein the backoff time is prior to the target signal.

19. The method of claim 16, wherein the target signal is associated with the synchronization signal, wherein the method further comprises:
decoding the synchronization signal prior to operating in the low power mode and to terminating the sample capture window.

20. The method of claim 19, wherein decoding the synchronization signal includes decoding the PBCH based on a PBCH decoding indicative of a presence of the PBCH with the synchronization signal.

21. The method of claim 16, wherein the target signal is associated with the synchronization signal and the PBCH, wherein the method further comprises:
decoding the synchronization signal and the PBCH prior to operating in the low power mode and to terminating the sample capture window.

22. The method of claim 21, wherein the synchronization signal and the PBCH are present in a single subframe;
wherein at least one of the synchronization signal or the PBCH includes a cell identifier for a cell which was obtained by the UE prior to the eDRx sleep mode of operation;
wherein operating in the low power mode based on a detection of at least one of the synchronization signal or the PBCH includes operating in the low power mode responsive to the decode of the synchronization signal and the PBCH from the single subframe and without samples or a detection of the at least one of the synchronization signal or the PBCH based on an associated termination of the sample capture window.

23. The method of claim 21, wherein the synchronization signal and the PBCH are present in different subframes, wherein decoding the synchronization signal and the PBCH prior to operating in the low power mode includes:
decoding the synchronization signal from a first subframe;
operating in the low power mode subsequent to the first subframe and prior to a second subframe that includes the PBCH; and
decoding the PBCH from the second subframe prior to operating in the low power mode subsequent to the target signal and prior to the PO.

24. The method of claim 23, wherein at least one of the synchronization signal or the PBCH includes a cell identifier for a cell which was obtained by the UE prior to the eDRx sleep mode of operation;
wherein operating in the low power mode based on the detection of at least one of the synchronization signal or the PBCH includes operating in the low power mode responsive to the decode of the synchronization signal and the PBCH from the different subframes and without samples or a detection of the at least one of the synchronization signal or the PBCH based on the associated termination of the sample capture window.

25. The method of claim 16, wherein the UE is an Internet of Things (IoT) device or a wireless device; or
wherein the low power mode of operation is at least one of the eDRx sleep mode of operation, an extended low power mode of operation, or a microsleep mode of operation, and is based on an associated termination of the sample capture window.

26. The method of claim 16, further comprising:
switching, prior to the switch from the eDRx sleep mode of operation to the eDRx active mode of operation, from the eDRx active mode of operation to the eDRx sleep mode of operation, wherein the switch from the eDRx sleep mode of operation to the eDRx active mode of operation is based on the switch from the eDRx active mode of operation to the eDRx sleep mode of operation.

27. The method of claim 16, further comprising:
outputting an indication of the operation in the low power mode based on the detection of at least one of the synchronization signal or the PBCH.

28. The method of claim 27, wherein outputting the indication of the operation in the low power mode based on the detection of at least one of the synchronization signal or the PBCH comprises:
storing, in a memory or a cache at the UE, the indication of the operation in the low power mode based on the detection of at least one of the synchronization signal or the PBCH.

29. An apparatus for wireless communication at a user equipment (UE), comprising:
means for switching, at a wakeup time for a start of a sample capture window that is prior to a target signal, from an extended discontinuous reception (eDRx) sleep mode of operation to an eDRx active mode of operation, wherein the target signal is associated with at least one of a synchronization signal or a physical broadcast channel (PBCH) of a network node; and
means for operating, subsequent to the target signal and prior to a paging occasion (PO), in a low power mode based on a detection of at least one of the synchronization signal or the PBCH.

30. A computer-readable medium storing computer executable code at a user equipment (UE), the code when executed by at least one processor causes the UE to:
switch, at a wakeup time for a start of a sample capture window that is prior to a target signal, from an extended discontinuous reception (eDRx) sleep mode of operation to an eDRx active mode of operation, wherein the target signal is associated with at least one of a synchronization signal or a physical broadcast channel (PBCH) of a network node; and
operate, subsequent to the target signal and prior to a paging occasion (PO), in a low power mode based on a detection of at least one of the synchronization signal or the PBCH.
